(19) United States
(12) Patent Application Publication
(10) Pub. No.: US 2009/0142724 A1
(43) Pub. Date: Jun. 4, 2009

(54) ILLUMINATION SYSTEM FOR DENTISTRY APPLICATIONS

(75) Inventors: Kenneth Rosenblood, Los Angeles, CA (US); Robert Hayman, Los Angeles, CA (US); Eric P. Rose, Los Angeles, CA (US); Eric Relyea, Los Angeles, CA (US); Christopher Quan, North Hills, CA (US)

Correspondence Address: DISCUS DENTAL, LLC, 8550 HIGUERA STREET, CULVER CITY, CA, 90232, US

(73) Assignee: DISCUS DENTAL IMPRESSIONS, LLC, Culver City, CA (US)

(21) Appl. No.: 11/764,176

(22) Filed: Jun. 15, 2007

Related U.S. Application Data
(63) Continuation-in-part of application No. 11/173,839, filed on Jun. 30, 2005.
(60) Provisional application No. 60/641,462, filed on Jan. 4, 2005.
(60) Provisional application No. 60/647,723, filed on Jan. 26, 2005.
(60) Provisional application No. 60/647,580, filed on Jan. 26, 2005.
(60) Provisional application No. 60/641,461, filed on Jan. 4, 2005.
(60) Provisional application No. 60/641,468, filed on Jan. 4, 2005.
(60) Provisional application No. 60/647,593, filed on Jan. 26, 2005.
(60) Provisional application No. 60/604,577, filed on Aug. 25, 2004.
(60) Provisional application No. 60/641,469, filed on Jan. 4, 2005.
(60) Provisional application No. 60/814,242, filed on Jun. 15, 2006.
(60) Provisional application No. 60/846,497, filed on Sep. 22, 2006.

(51) Int. Cl. A61C 3/00

(52) U.S. Cl. 433/29

(57) ABSTRACT

A dental illumination system includes an adjustable self-supporting frame and a lamp head coupled to the frame. The lamp head includes a housing and a spacer having formations that is adapted to removably mechanically couple the lamp head to a reference device, again having formations, for facilitating illumination of a tooth by a light source contained within the lamp head. The spacer and lamp head may be formed integrally. If formed separately, both the lamp head and the spacer may include formations.

### CROSS-REFERENCE TO RELATED APPLICATIONS

This application is a continuation-in-part of U.S. patent application Ser. No. 11/173,839, filed Jun. 30, 2005, which claims priority to provisional patent application Ser. Nos.: 60/641,462, filed Jan. 4, 2005, entitled “Boom Hinge For A Dental Lamp”; 60/647,723, filed Jan. 26, 2005, entitled “Boom Hinge For A Dental Lamp”; entitled “Lamp For Dentistry Applications”; 60/647,580, filed Jan. 26, 2005, entitled “Light Guide For Dental Whitening Lamp”; 60/641,461, filed Jan. 4, 2005, entitled “Support Structure For A Dental Lamp”; 60/641,468, filed Jan. 4, 2005, entitled “Light Guide For A Dental Whitening Lamp”; 60/647,593, filed Jan. 26, 2005, entitled “Support Structure For A Dental Lamp”; 60/604,577, filed Aug. 25, 2004, entitled “Lip Retractors”; and 60/641,469, filed Jan. 4, 2005, entitled “Lamp For Dentistry Applications”; and claims the benefit of U.S. provisional patent applications Ser. No. 60/814,242, filed Jun. 15, 2006, entitled “Illumination System for Dentistry Applications”, and Ser. No. 60/846,497, filed Sep. 22, 2006, entitled “Illumination System for Dentistry Applications”; the contents of which are hereby incorporated by reference.

### FIELD OF THE INVENTION

This invention relates to illumination systems used in dentistry. Specifically, this invention relates to illumination systems used in dental curing, dental whitening or imaging.

### BACKGROUND OF THE INVENTION

A tooth is comprised of an inner dentin layer and an outer hard enamel that is coated with a protective layer called the acquired pellicle. The enamel layer is composed of hydroxyapatite crystals that create a somewhat porous surface. The pellicle or the enamel can become stained or discolored. It is believed that the porous nature of the enamel layer is what allows staining agents and discoloring substances to permeate the enamel and discolor the tooth.

Tooth discoloration has a number of causes. For example, the teeth may become stained by coffee or tea drinking, or by the use of tobacco products, or by drinking water with a high mineral content.

One solution to the staining problem is through tooth bleaching. Some dentifrices, like toothpastes, gels, and powders, contain active oxygen or hydrogen peroxide liberating bleaching agents including peroxides, percarbonates and perborates of the alkali and alkaline earth metals or complex compounds containing hydrogen peroxide.

Dental bleaching can be done either in a dental office or at home. Bleaching in a dental office generally employs compositions activatable with the aid of light sources having the appropriate wavelength outputs in order to speed up the process. Additionally, the bleaching compositions used in a dental office typically contain a higher percentage concentration of bleaching agents than the bleaching compositions found in home applications.

In addition to staining, tooth decay, resulting in cavities or other damages can also result. In the field of tooth restoration and repair, dental cavities are often filled and/or sealed with compounds that are photosensitive, either to visible and/or ultraviolet light. These compounds, commonly known as light-curable compounds, are placed within dental cavity preparations or onto dental surfaces and are cured when exposed to light from a dental curing light device.

Unlike dental curing and imaging processes, which are generally relatively fast processes, dental bleaching takes a much longer time, sometimes amounting to more than an hour per office visit. On the other hand, dental restoration is often an unwelcome experience. Therefore, it is advantageous that a person undergoing the processes, either dental restoration or bleaching, be as comfortable as possible.

The process is generally performed in a dentist's chair. Typically a dentist's chair has a wide range of adjustability such that a patient may be placed in a wide range of positions from a nearly full reclining position to a nearly upright position. In order to effectively accomplish the whitening or restoration process, a light source needs to be aligned with the mouth. The wide range of dentist's chair positions can make this alignment difficult.

Further considerations in the process of dental procedures include the ability to maintain cleanliness of the light source, and particularly of any part that comes into contact with the patient. Further, the process of whitening is, for example, optimized, that is, the light source is on as long as necessary to whiten the teeth to the desired degree. Still further, it is desirable that the light source be as efficient as possible. An efficient lamp tends to be cooler and therefore safer than an inefficient lamp. Also, an efficient lamp requires less energy to run than an inefficient lamp.

It remains desirable to have an efficient and comfortable apparatus and method for dental whitening, curing and imaging.

### SUMMARY OF THE INVENTION

Summary of major aspects and embodiments. The present invention is directed to a system, an apparatus and method for dental whitening, curing, imaging, or therapeutic treatment that is efficient, comfortable for the patient and further includes improved safety, maintenance and operating features.

The present invention is also directed to an alignment system to facilitate faster patient set up and optimal results.

The alignment system includes an apparatus for positioning a dental illumination device relative to a subject, including a lamp system, a reference device, and a spacer for engaging both the reference device and the lamp system for positioning the lamp system at a predetermined distance from the reference device.

In one embodiment, the reference device and the spacer include formations that removably inter-engage as the reference device and spacer become apposed.

In another embodiment, the spacer and the lamp system include formations that removably inter-engage as the spacer and the lamp system become apposed.

In a further embodiment, the spacer and at least one of its formations are integrally formed with the lamp system.

The inter-engaging formations serve to stabilize the spacer axially and against twisting.

Furthermore, the present invention includes a support mechanism that is unobtrusive, easily adjustable, and able to provide positioning in multiple degrees of freedom so as to be adaptable to the requirements of patients of various sizes.

The lamp system and a support system include formations that removably inter-engage as the lamp system and the support system become apposed.

According to a first embodiment of the invention, a dental whitening or curing light source includes at least one light source such as, for example, an ultraviolet light source for activating a dental whitening or curing composition. The light source may include a lamp, an arc lamp such as a halogen light source, semiconductor light emitting devices, light-emitting chips such as an LED, a solid state LED, an LED array, a fluorescent bulb, and so on. In the case of dental imaging, the light source may include the above in addition to a laser, an x-ray or even an infrared source. According to a second embodiment of the invention, multiple light sources arranged in a geometric arrangement may be used. In one aspect, an illumination frame may be disposed inside the lamp head housing. In another aspect, the illumination frame may be in place of the lamp head housing as a self-contained structure. In a further aspect, the illumination frame may be in addition to the lamp head housing. The light sources may be collectively powered or individually powered. If individually powered, each of the individual light sources may be turned on or off separately, as desired.

In one embodiment, the illumination frame may be adapted to be coupled to the spacer and the spacer is adapted to be coupled to the reference device. In another aspect, the spacer may be an integral part of the lamp system, adapted to be coupled to the reference device. According to a further aspect, an illumination frame includes at least one light source set in the illumination frame to illuminate at least one tooth in the mouth of a dental patient.

In one embodiment, the illumination frame may, for example, conform to the jaw of a patient and have a first end and a second end. The first and second ends include a first and second formations, such as slots, configured to mate with a first and a second formation, such as a wing-like member, respectively, of a reference device such as a lip retracting device. The arcuate shape of the illumination system may be configured to follow the curvature of the human head so that the light sources are substantially equidistant from the various teeth in a dental patient. The light source may be capable of whitening, curing or imaging.

In another embodiment of the invention, the illumination frame is rectangular with a first slotted structure on one side of the rectangle and a second slotted structure on the opposite side of the rectangle configured to mate with wing-like members on a lip retracting device worn by a dental patient.

In one embodiment of the invention, a path is provided from a light source to a target such as a whitening composition disposed on a tooth surface, a filling compound residing either on the surface or in the cavity of a tooth, or a tooth for imaging. In one aspect, the light path includes a light source capable of imaging, whitening or curing. In another aspect, the light path includes a light source and at least one reflector integral to the light source. According to a further aspect, the invention includes a second reflector having an axial cavity with a first aperture at an end proximate the light source and a second aperture distal to the light source. The second reflector includes a reflective internal surface adapted to direct light from the light source towards the second aperture by reflection. In one embodiment, an optical lens is disposed within the second reflector. According to another embodiment, the optical lens includes at least one curved surface and is adapted to direct light from the light source towards the second aperture by refraction. According to yet another embodiment, an optical filter is disposed coincident with the second aperture. The optical filter serves to impede the passage of various wavelengths of light while allowing the passage of other wavelengths. In a further embodiment, the optical filter serves to prevent, for example, most light having a wavelength characterized as in the infrared range from passing through the second aperture to the target, if desired. In contrast, light in the ultraviolet and/or visible ranges are allowed to pass, if desired.

According to a further embodiment of the invention, a light path apparatus including a reflector, a lens, a filter, and a diffusion element is disclosed. The diffusing element may be used to spatially homogenize the spectrum output of a light source. According to one aspect of the invention, a diffusing element may be employed to produce scattering of light at an input surface thereof to generate a randomized and spatially equalized output light pattern. According to another aspect of the invention, the diffusing element includes a textured surface adapted to provide scattering of received light. In a further aspect, the diffusing element includes a frosted surface, for example, a frosted glass portion or a frosted glass produced by etching. In another example, a frosted plastic surface element is employed. As in the case of a frosted glass element, the plastic element may be frosted by etching, or by a mechanical crazing process. In other examples, the diffusing element may include a textured surface having a plurality of striations thereon, a plurality of ridges, a corrugated pattern, a plurality of microscopic hemispherical bumps, a plurality of microscopic conical projections, or any other surface feature adapted to produce the desired scattering of light. In still other examples of the invention, the diffusing element includes a transparent or translucent material having a plurality of suitably sized particles suspended in a layer, or otherwise throughout a body of the diffusing element. The suspended particles may be spherical, or may exhibit any other appropriate physical geometry.

According to one embodiment of the invention, the diffusing element is disposed between the light source and a lens. The lens serves to refract light received from the light source, directly or indirectly, by reflection from various surfaces, and to refract light towards the target area. In one embodiment, the lens includes a substantially rectangular periphery. In another embodiment, a peripheral edge of the lens is substantially circular, elliptical, or otherwise configured according to the particular requirements of any given embodiment of the invention. In a further embodiment, the lens includes a curved output surface region and a substantially flat input region. In yet another embodiment, the lens includes a curved input region and a substantially flat output region. In still another embodiment of the invention, the lens includes a curved output region, and an input surface that includes both curved and flat regions, where the curved region minimizes refractive characteristics of the lens within a particular area while providing desirable refraction in other portions of the illumination pattern produced by the light source, or light source and diffusing element.

According to another embodiment of the invention, a light path apparatus including a reflector, a lens, a filter, an integrator and diffusing element is disclosed. In one aspect, according to various embodiments of the invention, a light path apparatus includes a housing having a reflector surface and an integrator surface. The reflector surface redirects divergent rays of light towards an input of a lens, or lens system. The integrator surface redirects divergent rays of light received from an output surface of the lens or lens system towards an output aperture of the light path apparatus.

According to one embodiment of the invention, the light path apparatus housing is formed of metal, such as, for example, formed sheet metal. In another embodiment of the invention, the light path apparatus housing is formed of a polymer material, including, for example, a reinforced polymer composite material.

In still another embodiment of the invention, the light path apparatus includes an optical filter. The optical filter serves to absorb and/or reflect light of various wavelengths, and in particular wavelengths of desirable ranges in terms of the applications of the dental lamp system. For example, where an output of the dental lamp is desired to be principally within the ultraviolet spectrum, the optical filter will absorb and otherwise reject at least some light of visible and/or infrared wavelengths.

In one embodiment of the invention, the optical filter is disposed distal to the light source, such that the diffuser element and lens are disposed between the light source device and the optical filter. In one embodiment of the invention, the optical filter is disposed immediately adjacent to, or within, an aperture at an output and of the light path apparatus. Consequently, light suitable for activating a dental whitening compound, or for any other dentistry process, is available outside of the second aperture, if present. Meanwhile, for example, infrared light, which would otherwise unduly elevate the temperature of the target area, unless useful in a dental process, is excluded from the target area, or is reduced to acceptable levels.

According to at least one embodiment of the invention, an elastomeric mounting is provided to mechanically couple the filter in position in the light path. Furthermore, one embodiment of the invention includes another elastomeric mounting disposed to mechanically couple the optical lens to a position in the light path. The elastomeric mountings serve, in various aspects of the invention, to protect the lens and filter respectively against mechanical shock and to compensate for differences in coefficient of thermal expansion present between various materials employed in the device of the invention.

According to a further embodiment of the invention, a light source and reflector assembly are disposed within a lamp housing. The lamp housing includes fixturing features adapted to hold the light source and a reflector assembly within an axial cavity of the lamp housing. The lamp housing includes a rear aperture proximate to the light source and a front aperture proximate to the second aperture of the reflector.

According to at least one embodiment of the invention, at least one wavelength transformer may be included. The wavelength transformer may act to transform shorter wavelengths outside of the useful range for whitening imaging or curing, into longer wavelengths in the useful range, thus minimizing energy waste. In one aspect, the wavelength transformer may be disposed within the lamp housing. In another aspect, the wavelength transformer may be part of the light source. In a third aspect, the wavelength transformer may be constructed into a modular device adapted to be installed or removed from the lamp housing of the whitening, imaging or curing light source, whenever desired.

In another embodiment of the invention, a grill is disposed coincident with the rear aperture. In one aspect, the grill includes perforations for heat dissipation or to allow the passage of a cooling medium, such as air.

In one embodiment of the invention, the lamp housing also includes a cooling system for maintaining the light source, and other components of the lamp head at a desirable temperature, a high operating temperature of the light source notwithstanding. In one embodiment, the cooling system includes a fan. In another embodiment, the cooling system includes a heat sink. In still another embodiment, the cooling system includes heat pipes. In another embodiment, the cooling system includes phase change materials.

According to one embodiment of the invention, the housing includes a formation such as a mechanical coupling feature in proximity to the front aperture. The mechanical coupling feature provides, according to one embodiment of the invention, a secure, removable connection between the housing and a spacer.

Housing as used herein may include structures that contained a light source or sources.

In one embodiment of the invention, the spacer may be, for example, a light guide, having a first and a second formation. The first formation is adapted to removably couple the light guide to a light source or lamp, and the second formation is adapted to removably couple the light guide to a device for positioning the light guide, and consequently the lamp head and/or a light source, in a substantially constant position and orientation with respect to a target. In one aspect, the light guide may have a substantially tubular or substantially ellipsoidal shape. In another aspect, the light guide may have an aperture of any shape having an aspect ratio ranging from about 1:5 to about 1:2. An aperture at a proximal end of the light guide is adapted for positioning the light guide adjacent to the front aperture of the lamp housing. A further aperture exists at a distal end of the light guide. The light guide includes formations adapted to interface with the formations of the housing. The light guide may include a second formation adapted to removably couple the light guide to a reference device for positioning the light guide, as noted above, and consequently the lamp head and the light source, in a substantially constant position and orientation with respect to a target.

In another embodiment, one of the reference devices may be an adjustable mounting device. In one aspect, the adjustable mounting device may include one arm adapted to swing in from the mounting device mounted on the side arm, arm rest or the back portion of a dental chair. In another aspect, at least one other reference device may be a retracting device that is adapted to aid in the accurate positioning of the lamp head. In a still further aspect, a spacer may be adapted to be connected to a reference device that forms part of a light source positioning device attached to a back portion, side arm or arm rest of a dental chair.

In a further embodiment, the spacer may be adapted to be connected to a reference device that forms part of a light source positioning device that is attached to a portion of an armrest of the dental chair.

In a still further embodiment, the reference device may include a light distributor. Example of the light distributor includes a light pipe, a light guide; a mouthpiece, a tongue illuminator, an illumination plate, a dental tray, a dental floss, or combinations thereof.

In one embodiment, the light guide may be formed of a polymeric material having a spectral absorption characteristic, for example, visible light may readily pass through the walls of the light guide, while ultraviolet light may be either absorbed by the walls or, for example, may be reflected from the internal surfaces of the light guide. By allowing the transmission of visible light the light guide facilitates the installation of the light guide since the teeth of the patient may be quite visible through the walls of the light guide. By absorbing or reflecting light of ultraviolet wavelengths, the light guide serves to contain the ultraviolet radiation directed therethrough and to shield local soft tissues from the effects of such ultraviolet radiation.

The material of the light guide may be chosen to absorb and/or reflect light of one or more ranges of wavelength that impinges on the tubular inner surface. Consequently, according to one aspect of the invention, the light guide may reduce the degree to which light of the subject wavelengths escapes from the system except through the distal aperture of the light guide.

In another embodiment of the invention, the light guide is adapted to be limited to the use in the treatment of a single dental patient and may be thereafter disposable. In another embodiment, a control mechanism may be provided to inhibit the use of a light guide on additional patients after it has been once used. One aspect of the control mechanism is that the inhibition may occur during the attachment process of the light guide to the lamp system.

In one embodiment of the invention, the signal generating and record reading devices are located within the lamp housing. In another embodiment of the invention, one or more of the signal generating and record reading devices are located external to the lamp head housing.

One embodiment of the invention effects control of light guide usage by including a recording medium in the light guide, and a signal generating device elsewhere in the lamp system. In one aspect, the invention includes receipt by the recording medium of a signal from the signal generating device, and recording of a record of the recording medium corresponding to the received signal to produce a substantially permanent signal record. In another aspect of the invention, the substantially permanent signal record is read by a medium reading device and a condition of use of the particular light guide containing the recording medium is ascertained. Based on the condition of use indicated by the record, as read, a control device external to the light guide serves to allow or inhibit activation of the light source.

In one embodiment of the invention, the signal from the signal generating source is received at the recording medium by way of an electromechanical coupling, for example, wired or wireless. In another embodiment of the invention, the signal from the signal generating source is received at the recording medium by way of an optical communication channel. In a still further embodiment of the invention, the signal from the signal generating source is received at the recording medium by way of a mechanical communication channel, an acoustic communication channel, a radiofrequency communication channel, or any other communication medium that is appropriate to the particular invention embodiment.

According to one embodiment, a single-use light guide includes a write once read many times (WORM) memory device. In a particular aspect of the invention, the WORM memory device is adapted to receive a signal related to the duration of use of a related instance of a light guide, and to substantially indelibly record the information content of the signal for later use by a control subsystem of a light source.

In a further embodiment of the invention, a plurality of light guides each have an output end having a respective size, wherein the size of a particular output end corresponds to a mouth size of a particular patient or class of patients. For example, light guides in various embodiments may be provided that are most appropriate to use by a large adult, a small adult, or a child.

In one embodiment of the invention, the reference device is a lip retracting device having geometric formations adapted to receive one or more lips of a patient in a tooth restoration, imaging or whitening process.

In one aspect, the light guide and the lip retracting device provides an interlocking system for optical alignment of the light source with the target, allowing for fool-proof set up, and promoting patient safety during a dental procedure.

In another aspect, soft foam or elastomeric cushions are disposed along the edge of the light guide that interfaces with the lip retracting device to provide custom forming to each patient's profile for additional comfort.

In one embodiment, the light guide includes air vents for patient breathing comfort during the bleaching or curing treatment or during imaging.

According to the present invention, the reference device may include a lip retracting device having formations adapted for repeatably positioning a user's lips with respect to a light output port, a light guide, an examination or an imaging device such as a cone-shaped structure.

In one embodiment of the present invention, a lip retracting device includes at least two channel retainers or flanges, at least one resilient member, and at least two wing-like members or flanges, wherein each of the channel retainers includes a race, an inside side wall, an outside side wall, and each of the wing-like members is spaced away from the attachment of the resilient member. Each of the wing-like members may be adapted to fit into a formation such as a slot in an output port, a light guide, an examination or an imaging device such as a cone. In one aspect, each of the resilient members is attached to the inside side wall of two adjacent channel retainers by means of an adhesive or heat sealing, and includes two arches; and each of the wing-like flanges or members is attached to a channel retainer by means of an adhesive or heat sealing.

In another aspect, each of the resilient members is integrally molded to the inside side wall of the two adjacent channel retainers and includes two arches; and each of the wing-like flanges or members is integrally molded to a channel retainer.

According to another embodiment of the invention, a lip retracting device includes at least a pad attached or molded to the resilient member about the area of the arch.

According to yet another embodiment of the invention, a lip retracting device includes at least two channel retainers, at least two wing-like flanges and a tongue retainer, the channel retainers being held in a spaced apart relationship by at least one resilient member, the wing-like flanges being integrally attached or molded to the channel retainers and the tongue retainer being attached to two of the channel retainers.

According to a further embodiment of the present invention, the lip retracting device includes four channel retainers or flanges, four resilient members, and two wing-like members or flanges, wherein each channel retainer includes a race, an inside side wall, an outside side wall; each resilient member is integrally molded or attached to two outside side walls of two adjacent channel retainers and includes an arch; and each wing-like member or flange is integrally molded or attached to a channel retainer or flange at a location that is spaced away from the attachment area of the resilient member. The attachment may be accomplished by an adhesive or heat sealing. Each of the wing-like members is adapted to fit into a formation, such as a slot in an output port, a light guide, an imaging or an examination device such as a cone.

According to yet a further embodiment of the present invention, a lip retracting device includes four channel retainers, a plurality of resilient members, and a tongue retainer, the channel retainers being held in a spaced apart relationship by at least one resilient member having an arch, and the tongue retainer being attached to two of the channel retainers by two secondary resilient members.

According to a still further embodiment of the invention, a lip retracting device includes at least two pads, attached or molded to a resilient member.

According to still another embodiment of the invention, there is provided a lip retracting device for accommodating a dental treatment composition, for example, a whitening composition. In one aspect, the retracting device may further include a u-shaped channel configured to accommodate the lower, or alternatively the upper, set of a user's teeth. The u-shaped channel supports the channel retainers in substantially fixed spatial relation with respect to one another. In another aspect, the arch of the retracting device may be configured to accommodate a u-shaped channel.

In still yet another embodiment, a lip or cheek retracting device may include two channel retainers that may be biased with a resilient member lying substantially below the mouth of the patient during use. The lip or cheek retractor may further include pads on the channel retainers to cushion the lips of the patient.

In one aspect, any of the lip retracting devices described above may be fitted with a tab for grasping and for facilitating insertion and removal.

In one embodiment, the lip retracting device may also be adapted for use by a single patient and is thereafter disposable. One aspect of the control mechanism is that the inhibition occurs during the attachment process of the lip retracting device to the light guide.

In another embodiment, the lip retracting device useage may also be controlled by including a recording medium, for example, about the wing-like members, and a signal generating device elsewhere in the lamp system, as disclosed above for the control use of a light guide. In another example, when both the spacer and formations, for example, slots for mating with the wing-like members of the lip retracting device, are integrally part of or attached to the lamp housing, for example, to an illumination frame, the signal generating device may be present in the lamp housing.

In a further embodiment, a reference device may be held in place by the natural compression of the lips of the patient. The device includes wings that provide positioning and alignment to a mating formation on an imaging apparatus. The configuration enables patients to hold a position during imaging with comparatively little effort.

In one aspect, a reference device includes a passively held portion to anchor it to a subject of dental imaging. The reference device further includes a first alignment formation coupled to the passively held portion where the first alignment formation provides alignment to at least one dental feature. The reference device further includes a second alignment formation coupled to an imaging device where the second alignment formation is shaped and configured to mate with the first alignment formation to the imaging device in a substantially fixed position with respect to the at least one dental feature. The reference device may include a film holder coupled to the passively held portion. The film holder locates imaging film, or an imaging sensor, for imaging the at least one dental feature.

In one embodiment, the reference device may be a single-use device, and the imaging film, or imaging sensor may be integrally formed with the holder.

According to another embodiment of the invention, the lamp housing or the housing of the illumination frame includes formations, for example, a ball member having a convex spheroid surface. The ball member is adapted to be received in formations such as a ball cavity having a corresponding concave spheroid surface.

In one embodiment of the invention, the ball cavity is coupled to one end of a support boom. The support boom may be supported by a mast. According to one embodiment of the invention, a ball joint is formed by the combination of the ball member and ball cavity. The ball joint permits ready positioning of the lamp head, and consequently, of the front aperture of the lamp head and of a light guide coupled to the lamp head housing, in a wide variety of positions and orientations with respect to the balance of the lamp system.

In a further embodiment of the invention, a boom joint is provided for coupling the mast to the boom of the dental whitening, imaging, or curing lamp to form an articulated support system. In various embodiments, the boom joint is adapted to maintain the boom in a fixed position and orientation with respect to the mast, subject to subsequent release. In a further aspect of various invention embodiments, the boom joint is adapted to permit both pitch and yaw motions of the boom with respect to the mast.

According to still another embodiment of the invention, one or more of the boom and the mast are arcuate in form, and consequently an efficient use of space is possible within the confines of a dental examining room.

According to a still further embodiment of the invention, the lamp head may include a housing having formations that are adapted to removably or permanently mechanically couple the lamp head to at least one reference device, also having formations, for facilitating illumination at least a portion of an oral cavity, for example, a tooth, by a source of radiation, as noted above. At least one reference device may be adapted to be located about at least a portion of a support system supporting the weight of the person undergoing treatment. In one embodiment, the support system is a dental chair. According to one aspect, the reference device may be located about the back portion of the dental chair. In another aspect, the reference device may be located about the arm portion of the dental chair.

According to another embodiment of the invention, the lamp housing or the housing of the illumination frame includes formations, for example, a ball member having a convex spheroid surface. The ball member is adapted to be received in formations such as a ball cavity having a corresponding concave spheroid surface.

In one embodiment of the invention, the ball cavity is supported by a mast which is, in turn, supported by a surface-supported base. In one aspect of various embodiments, the base may be the arm portion of a dental chair, or the back portion of a dental chair. The dental chair may be supported by a wheeled mobile base.

According to one embodiment of the invention, a ball joint is formed by the combination of the ball member and ball cavity. The ball joint permits ready positioning of the lamp head, and consequently, of the front aperture of the lamp head and of a light guide coupled to the lamp head housing, in a wide variety of positions and orientations with respect to the balance of the lamp system.

In a further embodiment of the invention, a boom joint is provided for coupling the mast to the boom of the dental whitening, imaging, therapeutic or curing lamp to form an articulated support system. In various embodiments, the boom joint is adapted to maintain the boom in a fixed position and orientation with respect to the mast, subject to subsequent release. In a further aspect of various invention embodiments, the boom joint is adapted to permit both pitch and the boom with respect to the mast.

In one aspect, the lamp head having the light source and optical components may be in modular form. In another aspect, the control for the light source may be enclosed within a power pack. The power pack may be in modular form for easy installation and removal.

In one embodiment, the power pack may have a display panel for displaying the status of a dental process. In another embodiment, the pack may include a voice alert system for alerting the dental professional of the status of a dental process.

In one embodiment, at least portions of the whitening composition may be in a tray. The tray may be positioned in the patient's mouth using a reference device such as a lip retracting device.

In another embodiment of the invention, an illumination frame may be mounted to a lamp head. In one arrangement, the lamp head provides support for the illumination frame. In another arrangement, the lamp head provides power to the illumination frame. In yet another arrangement, the lamp head may be mounted to an adjustable floor stand or portions of the dental chair, as noted above, that provides further adjustability for the dental illumination system. In still another arrangement, the illumination frame may be used in place of the lamp head and may be mounted directly to an adjustable floor stand or portions of the dental chair, as noted above. In one aspect, the illumination frame has a non-reflective surface in which the light sources are set. In one embodiment, the non-reflective surface is a coating on the illumination frame. In a second embodiment, the non-reflective surface is a layer of material adhered to the illumination frame. In a third embodiment, the illumination frame is made of a non-reflecting material. In a still further embodiment of the invention, the illumination frame may have a reflective surface.

In another embodiment of the invention, the dental illumination frame includes a plurality of light sources emitting light of substantially the same wavelength. In another embodiment of the invention, the dental illumination frame includes a plurality of light sources emitting light of different wavelengths.

In yet another embodiment of the invention, the dental illumination system has an arcuate illumination frame having tapered ends. The tapered ends result in less bulk in the illumination frame close to the patient's mouth. In an alternative arrangement, each of the tapered ends includes a slot wherein the slots are configured to mate with wings of a lip retracting device worn by a dental patient.

In still another embodiment of the invention, the dental illumination system has protruding light sources to enable the dental illumination system to provide more light from the light sources. In an alternative embodiment of the invention, the dental illumination system has light sources that are located flush with the illumination frame.

In yet still other embodiments of the invention, the dental illumination system may include an optical filter system to modify the optical and/or physical properties of the light coming from the light source or to alter the nature of a therapeutic light treatment. The optical filter system may include a filter, a diffuser or combinations thereof.

In one aspect, the filter system may be positioned in or out of the direct path of the light source. In one embodiment, the spacer may include a filter system that may be removably attached to it. In another embodiment, the lamp head may include a filter system that may be positioned in or out of the direct path of the light source. In a further embodiment, the lamp head may include a filter system that may be removably attached to it. In another aspect, the filter system may be positioned in the direct path of the light source and be electronically controlled to either change or not change the nature of the nature of the light coming from the light source. In one embodiment, the filter system may be completely transparent to the light coming from the light source so that it will transmit about 100% of the light as is. In another embodiment, the filter system may have varied effect on the light coming from the light source, for example, only transmitting a wavelength and blocking another wavelength.

In one embodiment of the invention, a path is provided from a composition disposed on a tooth surface, a filling compound residing either on the surface or in the cavity of a tooth, or a tooth for imaging. In one aspect, the light path includes a light source capable of imaging, whitening, curing or providing therapeutic effects. Therapeutic effects as use herein may include exposing to a therapeutically effective amount of light to improve oral health; a therapeutically effective amount of both light and an oxidizing agent to improve oral health; a therapeutically effective amount of both light and at least one auxiliary chemical agent that increases the susceptibility of oral bacteria to light; or a therapeutically effective amount of light while simultaneously being subjected to an auxiliary or therapeutically effective physical or mechanical action. An “effective amount” or “therapeutically effective amount” refers to the amount of light and optional agent or action which is required to confer therapeutic effect on the treated subject. In another aspect, the light path includes a light source and at least one reflector integral to the light source. According to a further aspect, the invention includes a second reflector having an axial cavity with a first aperture at an end proximate the light source and a second aperture distal to the light source. The second reflector includes a reflective internal surface adapted to direct light from the light source towards the second aperture by reflection. In one embodiment, an optical lens is disposed within the second reflector. According to another embodiment, the optical lens includes at least one curved surface and is adapted to direct light from the light source towards the second aperture by refraction. According to yet another embodiment, an optical filter system is disposed coincident with the second aperture. The optical filter system serves to impede the passage of various wavelengths of light while allowing the passage of other wavelengths, or allowing a more uniform illumination of the target, respectively. In one aspect, the optical filter system may be positioned in front of the spacer when the spacer is positioned in front of the light source. In another aspect, the optical filter system may be positioned within the lamp housing. In a further aspect, the optical filter system may be removably mounted at the front of the lamp housing to vary the amount and/or the wavelength of the light emitting from the light source. The attachment may be effected by an adhesive, a magnetic attraction, a friction fit, a bolt or bolts, a screw or screws, other similar attachment methods, or combinations thereof. The filter may also be adapted for swinging up, down or away from the spacer or lamp housing. In a further embodiment, the optical filter serves to prevent, for example, most light having a wavelength characterized as in the infrared range from passing through the second aperture to the target, if desired. In contrast, light in the ultraviolet and/or visible ranges are allowed to pass, if desired.

In some aspects, the dental illumination system may include dental devices that may include a method of containing and/or shielding electromagnetic radiation.

In one embodiment, a shielding method includes a physical barrier to electromagnetic radiation that may be integral to a dental device and may be utilized to wholly or partially reflect, deflect, absorb and/or otherwise contain electromagnetic radiation.

In another embodiment, an attachable or otherwise accessory barrier may be utilized to contain electromagnetic radiation from a dental device.

In one aspect, an electromagnetic barrier may include a material capable of substantially blocking electromagnetic radiation in one form or another that may form a physically defined containment space or zone. The material may be applied as a film, a shielding layer or casing, and/or any other formation suitable for intercepting generated electromagnetic radiation from a dental device.

In some embodiments, an electromagnetic barrier may be constructed as an enclosing shell of conductive material. Conductive materials such as, for example, metals may be capable of blocking electromagnetic radiation based on their response to incoming radiation. One such response, referred to as plasmon resonance, defines a threshold of electromagnetic radiation that may be reflected by a metal based on its electron response to incoming radiation. In general, the plasmon frequency of a material defines the point that electromagnetic radiation of a higher frequency is transmitted while frequencies below are reflected. In many metals, this frequency is in the ultraviolet range of the electromagnetic spectrum, making metals effective reflectors at lower frequencies such as the visible, infrared, microwave and radio ranges of the spectrum. Metals are also, in general, dense materials that, by virtue of their density, may be able to block electromagnetic radiation by absorption. One common metal utilized for this property is lead.

Encasing conductive barriers may also serve as shielding for electronic components of a dental device. In addition to the blocking properties offered by such barriers, continuous conductive barriers may also be capable of substantially limiting the effects of an external electric field on its interior. Such barriers are often referred to as Faraday Cages and may operate on the principle that applying an external electric field to an enclosed conductive shell results in no electric field inside the shell. This is due to the conductive shell diverting the energy of the field within itself by the generation of a current, resulting in no net potential difference within the shell and thus, no internal electric field.

In an exemplary embodiment, an electromagnetic barrier may be constructed by coating the inner surface of a dental device housing or casing with a layer of conductive material. As the housing or casing often substantially surrounds electrical and electronic components of a device, such a layer may be effective in creating a substantially encompassing barrier that may be capable of reducing emitted electromagnetic radiation.

In other embodiments, the housing or casing may be constructed from a conductive material.

In yet other embodiments, an electromagnetic barrier may be a separate component that may include a conductive enclosure that may substantially contain the electrical components of a dental device.

In still further embodiments, an attachable or otherwise accessory electromagnetic barrier may be utilized. An attachable or accessory barrier may, for example, include an externally applied conductive layer.

In some embodiments, an electromagnetic barrier may also be included in the housing of a power source such that it may substantially reduce emission of electromagnetic radiation.

The present invention together with the above and other advantages may best be understood from the following detailed description of the embodiments of the invention illustrated in the drawings below.

### BRIEF DESCRIPTION OF THE FIGURES

FIG. 1 shows, in perspective view, a dental whitening or curing lamp according to one embodiment of the invention;

FIG. 1a shows, in perspective view, a dental whitening or curing lamp according to one embodiment of the invention;

FIG. 1b shows, in perspective view, a dental whitening or curing lamp mounted the head of a dental chair according to one embodiment of the invention;

FIG. 1c shows, in perspective view, a dental whitening or curing lamp mounted the arm of a dental chair according to one embodiment of the invention;

FIG. 1d shows, in perspective view, a dental whitening or curing lamp mounted from the floor of a dental office;

FIG. 1e shows, in perspective view, a dental whitening or curing lamp mounted from the ceiling of a dental office;

FIG. 1f shows, in perspective view, a dental whitening or curing lamp mounted from the wall of a dental office;

FIG. 2 shows, in cross section, various components of a whitening or curing lamp head, according to one embodiment of the invention;

FIG. 3 shows, in assembly drawing format, several components of a dental whitening or curing lamp according to one embodiment of invention;

FIG. 4 shows, in perspective view, components of a lamp head according to one embodiment of the invention;

FIG. 4a shows, a reflector and integrator assembly according to one embodiment of the invention;

FIG. 5 shows, in perspective view, a lamp head and boom according to one embodiment of the invention, and illustrates the removability of the lamp head from the boom according to one aspect of the illustrated embodiment;

FIG. 6 shows, in perspective view, a lamp head according to one embodiment of the invention;

FIG. 7 shows a mechanical and electrical coupling between a lamp head and boom according to one embodiment of the invention;

FIG. 7a shows an embodiment of a ball and socket joint;

FIG. 8 shows, in assembly drawing format, a lamp head joint according to one embodiment of the invention;

FIG. 8a shows, in sectional perspective view, components of a ball joint;

FIG. 9 shows, in perspective view, a grill and an electrical connector of a lamp head according to one embodiment of the invention;

FIG. 10 shows, in perspective view, an illumination frame according to one embodiment of the invention;

FIG. 10a shows an embodiment of an illumination frame with multiple planar light emitting surfaces;

FIG. 11 shows, in perspective view, a dental whitening or curing lamp according to one embodiment of the invention;

FIG. 12 shows an exploded view of a light guide with an illumination frame;

FIG. 13 shows, in perspective view, an illumination frame having slots according to one embodiment of the invention;

FIG. 14 shows, in perspective view, a light guide according to one embodiment of the invention;

FIG. 14a shows, in perspective view, a light guide including length adjustment formations according to one embodiment of the invention;

FIG. 14b shows, in perspective view, a light guide including length adjustment formations according to another embodiment of the invention;

FIG. 15 shows, in perspective view, a light guide including a recording device according to one embodiment of the invention;

FIG. 15a shows, in exploded perspective view, a light guide having a recording device and an elastic protector;

FIG. 16 shows, in perspective view, a dental lamp head adapted to be coupled to a light guide according to one embodiment of the invention;

FIG. 16a shows a top view of a dental lamp head adapted to be coupled to a light guide according to one embodiment of the invention;

FIG. 16b shows a rear elevation of a dental lamp head adapted to be coupled to a light guide according to one embodiment of the invention;

FIGS. 17 and 17a depict a semi-schematic perspective view of a lip retracting device provided in accordance to one embodiment of the present invention;

FIG. 17b depicts a semi-schematic perspective view of an alternative lip retracting device provided in accordance to another embodiment of the present invention;

FIG. 18 depicts a semi-schematic bottom plan view of the lip retracting device of FIG. 17b fitted into a device, such as an output port, a light guide of a lamp source or an examination cone;

FIG. 18a shows a top view of an illumination frame mated with a lip retracting device according to one embodiment of the invention;

FIG. 18b shows another embodiment of an illumination frame mated with a lip retracting device according to one embodiment of the invention;

FIG. 19 shows, in perspective view, a cheek retracting device according to one embodiment of the invention;

FIG. 19a shows a front view of a cheek retracting device;

FIG. 19b shows, in perspective view, a cheek retracting device with extended wings according to one embodiment of the invention;

FIG. 20 shows an exploded view of the combination of a lip retracting device with the light guide and a lamp;

FIG. 20a shows, in perspective view a stationary imaging stand according to one embodiment of the invention;

FIG. 20b shows an embodiment of the invention including a dental support structure and a dental imaging fixturing system;

FIG. 20c shows another embodiment of the invention including a dental support structure and a dental imaging fixturing system;

FIG. 20d shows an exploded view of the combination of a light guide, optical filter system and a lamp;

FIG. 20e shows, in perspective view, a lamp with an optical filter system;

FIG. 20f shows an embodiment of a light guide with an integrated optical filter system;

FIG. 21 shows, in block diagram form a control system for a dental lamp according to one embodiment of the invention;

FIG. 22 is a flow chart of the start process of the control system of FIG. 24; and

FIG. 23 is a flow chart of the lamp system monitoring process of the control system of FIG. 24.

FIG. 24 shows a view of a power pack according to one embodiment of the invention;

FIG. 25 illustrates methods of electromagnetic shielding in some embodiments of the invention;

### DETAILED DESCRIPTION OF THE INVENTION

The detailed description set forth below is intended as a description of the presently exemplified tooth bleaching and dental material curing methods and apparatus provided in accordance with aspects of the present invention and is not intended to represent the only forms in which the present invention may be prepared or utilized. The description sets forth the features and the steps for preparing and using the tooth bleaching and dental material curing methods and apparatus of the present invention. It is to be understood, however, that the same or equivalent functions and components incorporated in the tooth bleaching and dental curing methods and apparatus may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the exemplified methods, devices and materials are now described.

The present invention is directed to an illumination system for dental whitening, therapeutic treatment, imaging or curing. The lamp system may provides a therapeutic effect to the oral cavity, may activate a whitening substance, a therapeutic composition, or filling composite applied to a patient's teeth and/or gums with light from a light source.

In dental whitening, cleaning therapeutic treatment, and/or bleaching agents are applied to the teeth of a patient, for example. In tooth repair or restoration, composite filling materials are applied to surface and/or cavity in a tooth. In dental treatment, a therapeutic agent may be applied to the tissues, tongue, gums and/or tooth or teeth. The bleaching agents, therapeutic agents, and/or composite materials are activated by the application of energy, such as, for example electromagnetic energy. In imaging, the light source produces an image of the tooth or teeth of a patient, either by direct imaging, for example, using x-rays, or by indirect imaging or trans-illumination.

For effective activation or imaging while reducing spurious heating of the teeth, surrounding tissues, and/or tongue, electromagnetic energy of a particular wavelength, optimized for, for example, the activation of the particular chemicals in use, may be provided. For example, it is known to apply radiation in the visible and ultraviolet domains from a light source to the tooth or teeth of the dental patient to activate a whitening compound or filling composite.

Another way of enabling effective chemical activation of a dental whitening compound is to position a light source to fully illuminate the tooth surfaces being treated.

Since light intensity varies as the inverse cube of distance from a light source, it is desirable that the light source used be in reasonably close proximity to the tooth surfaces being treated. Also, because some of the light effective for chemical activation of a dental whitening or curing compound, or for imaging may also be deleterious to soft tissues, it is desirable to minimize the exposure of a patient's gums, tongue, facial skin and other soft tissues to the light source.

In view of these considerations, it is desirable that an illumination system be capable of rapid and reliable positioning of the light source in proximity to a patient's teeth or mouth.

To accomplish this, a reference device, such as a lip or cheek retracting device and a spacer, such as a light guide, include formations that may inter-engage as the reference device and spacer become apposed, in one aspect. In another aspect, the spacer and the lamp system include formations that removably inter-engage as the spacer and the lamp become apposed. The inter-engaging formations may serve to stabilize the spacer axially and against twisting.

The reference device may also include at least one light distributor, such as one light pipe, at least one light guide; a mouthpiece, a tongue illuminator, an illumination plate, a dental tray, a dental floss or combinations thereof, as noted above. Embodiments of the light distributor are described in more detail in U.S. patent application Ser. No. 11/344,974, and U.S. provisional application Ser. Nos. 60/814,239, entitled “Method and Device for Improving Oral Health” filed on Jun. 15, 2006; 60/892,859, entitled “Device and Method for Improving Oral Health” filed Mar. 4, 2007; and 60/649,402 entitled, “Method and Device for Improving Oral Health” filed Feb. 2, 2005; the contents of which are hereby incorporated by reference.

The lamp system and a support system may include formations that inter-engage as the lamp system and the support system become apposed.

The word formation as used herein in relation to the reference device, spacer, the lamp system and a support system refers to the portion of the reference device, spacer and lamp system which is shaped to inter-fit with a corresponding part of an adjoining component. It includes portions of the above listed article which are shaped by molding, or portions which are formed separately and then subsequently assembled. Some formations are adapted for extending the length of a device.

Suitable inter-engaging formations include tongues and grooves, posts and sockets, swingable hooks and sockets, resilient clips and sockets, tongue or wing-like members and slots, ball and cavity, ball and socket, some of which are more specifically exemplified in detail below.

The dental process includes protecting a patient's soft tissues which typically involves applying a soft overlay such as a sheet of rubber or foam over the patient's gums and other soft tissue. In a curing process, the overlay maybe applied to the unaffected teeth as well. The patient's soft tissues may alternatively be protected by, for example, opaque gauze pads or by non-UV light-curable, UV light-blocking masking chemicals. After the patient's soft tissues have been protected, a whitening composition or a filling composite is applied to the teeth or tooth. The composition is then activated with light from the lamp system. The light system of the present invention may be easily aligned to a subject and is ergonomically compatible for both right-handed and left-handed users. Further, the pieces of the light system are separable and modular, so that the light system is easy to assemble, disassemble, pack, ship or transport. In addition, individual pieces or modules may be sent in for repair or for updating.

The rubber material useful for the soft overlay may include either natural or synthetic rubber. Synthetic rubbers may be, for example, elastomeric materials and may include, but not limited to, various copolymers or block copolymers (Kratons®) available from Kraton Polymers such as styrene-butadiene rubber or styrene isoprene rubber, EPDM (ethylene propylene diene monomer) rubber, nitrile (acrylonitrile butadiene) rubber, latex rubber and the like. Foam materials may be closed cell foams or open cell foams, and may include, but is not limited to, a polyolefin foam such as a polyethylene foam, a polypropylene foam, and a polybutylene foam; a polystyrene foam; a polyurethane foam; any elastomeric foam made from any elastomeric or rubber material mentioned above; or any biodegradable or biocompostable polyesters such as a polylactic acid resin (comprising L-lactic acid and D-lactic acid) and polyglycolic acid (PGA); polyhydroxyvalerate/hydroxybutyrate resin (PHBV) (copolymer of 3-hydroxy butyric acid and 3-hydroxy pentanoic acid (3-hydroxy valeric acid) and polyhydroxyalkanoate (PHA) copolymers; and polyester/urethane resin.

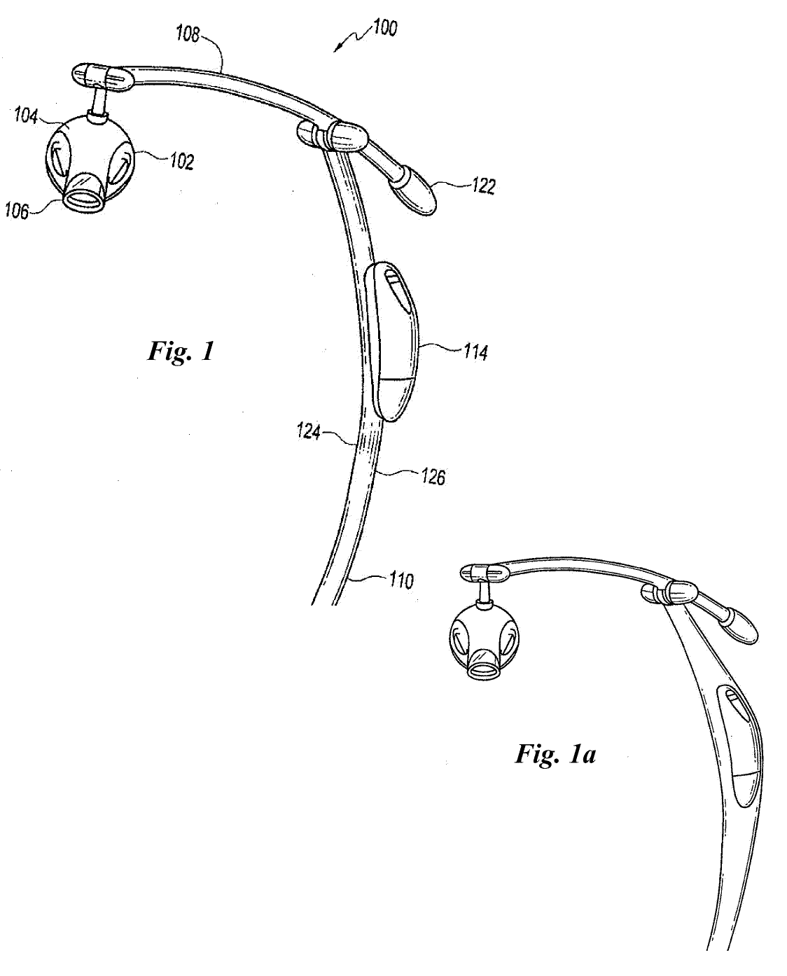

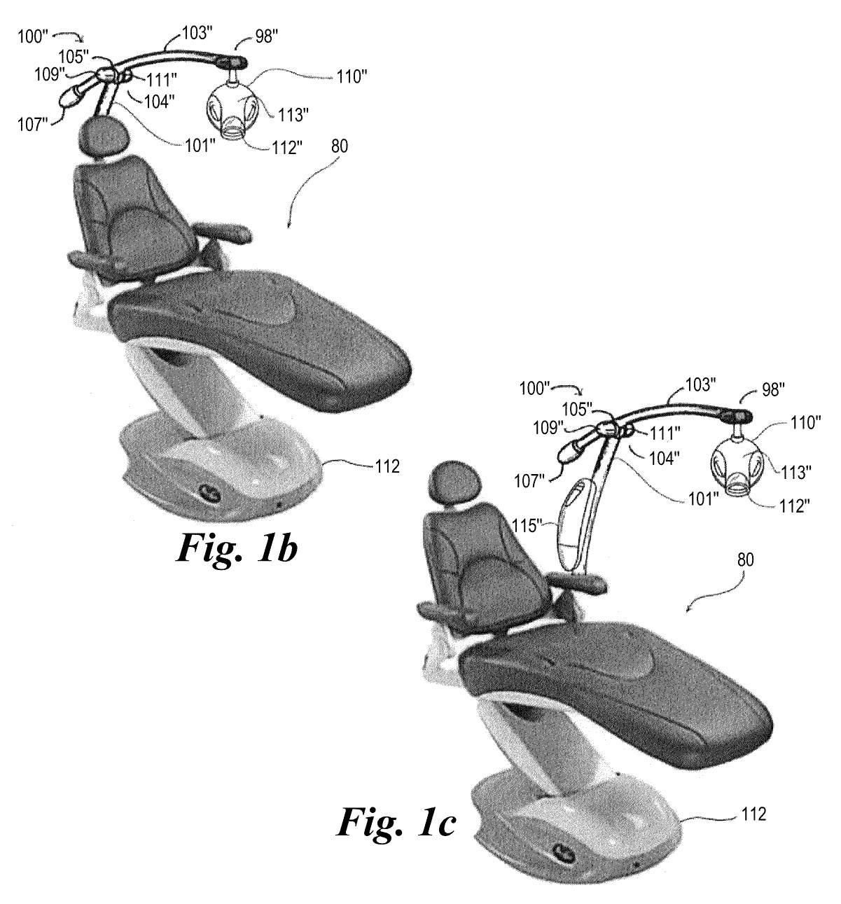

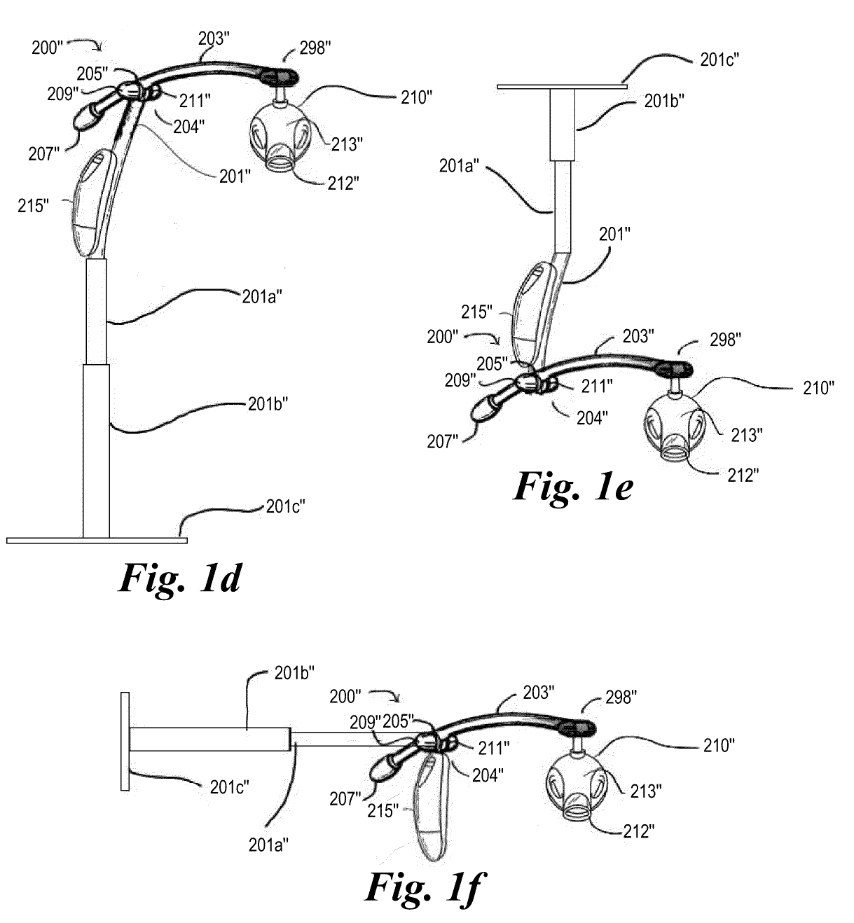

FIG. 1 is a perspective view of a dental whitening, imaging or curing lamp system 100 according to one embodiment of the present invention. The lamp 100 includes a lamp head 102 having a lamp head housing 104 and a light guide 106. The lamp head 102 provides the light that, for example, activates a whitening substance or curing composite applied to a patient's teeth by directing the light through the light guide 106. This lamp system may be used in a dental office or a dental laboratory.

The lamp housing 104 and head 102 may be made of any polymeric material, for example, a polymer that can be molded or cast; or a metal or metallic alloy. Suitable polymers include polyethylene, polypropylene, polybutylene, polystyrene, polyester, acrylic polymers, polyvinylchloride, polyamide, or polyetherimide like ULTEM®; a polymeric alloy such as Xenoy® resin, which is a composite of polycarbonate and polybutyleneterephthalate or Lexan® plastic, which is a copolymer of polycarbonate and isophthalate terephthalate resorcinol resin (all available from GE Plastics), liquid crystal polymers, such as an aromatic polyester or an aromatic polyester amide containing, as a constituent, at least one compound selected from the group consisting of an aromatic hydroxycarboxylic acid (such as hydroxybenzoate (rigid monomer), hydroxynaphthoate (flexible monomer), an aromatic hydroxyamine and an aromatic diamine, (exemplified in U.S. Pat. Nos. 6,242,063, 6,274,242, 6,643,552 and 6,797,198, the contents of which are incorporated herein by reference), polyesterimide anhydrides with terminal anhydride group or lateral anhydrides (exemplified in U.S. Pat. No. 6,730,377, the content of which is incorporated herein by reference) or combinations thereof.

In addition, any polymeric composite such as engineering prepregs or composites, which are polymers filled with pigments, carbon particles, silica, glass fibers, conductive particles such as metal particles or conductive polymers, or mixtures thereof may also be used. For example, a blend of polycarbonate and ABS (Acrylonitrile Butadiene Styrene) may be used for the lamp housing and head.

Generally, polymeric materials or composites having high temperature resistance are suitable.

Suitable metal or metallic alloys may include stainless steel; aluminum; an alloy such as Ni/Ti alloy; any amorphous metals including those available from Liquid Metal, Inc. or similar ones, such as those described in U.S. Pat. No. 6,682,611, and U.S. Patent Application No. 2004/0121283, the entire contents of which are incorporated herein by reference.

A liquid crystal polymer or a cholesteric liquid crystal polymer, one that can reflect rather than transmit light energy, may be used, either as a coating or as the main ingredient of the housing 104 and/or lamp head 102, to minimize escape of light energy, as described, for example, in U.S. Pat. Nos. 4,293,435, 5,332,522, 6,043,861, 6,046,791, 6,573,963, and 6,836,314, the contents of which are incorporated herein by reference.

The lamp head 102 is attached to a first end of a boom 108, as shown in FIGS. 1 and 1a. The lamp head 102 is positionable with respect to the boom 108 and has a wide range of motion with respect to the end of the boom 108. The boom 108 is supported by a mast 110. In the illustrated embodiment of FIGS. 1 and 1a, the boom 108 is pivotally mounted to the mast 110 at a point on the boom 108 closer to a second end of the boom 108 than the lamp head housing 104.

The boom 108 is adjustably positionable with respect to the mast 110. The boom 108 has both a rotational and a tilt range of motion with respect to the mast 110. A counterweight 122 on the second end of the boom 108 provides a counterbalance for the lamp head 102.

The boom 108 and mast 110 may be fashioned out of any polymer or metal, such as those mentioned above for use in the lamp housing 104. Here, since the boom 108 and mast 110 are less likely to be subjected to any potentially high temperature environment, the suitable materials need not be of high temperature resistance. On the other hand, structural integrity is a more desirable feature.

The housing of the power pack 114 may also be made out of any polymer or metal providing structural integrity, such as the materials mentioned above for use in the lamp housing 104.

In operation, the lamp system 100 is positioned with respect to the patient in a dental chair (not shown). The location of the power pack 114 on the mast 110 enables the lamp system 100 to be operated whether the lamp system 100 is positioned to the right or to the left side of the patient. The curvature of the mast 110 enables the lamp system 100 to be positioned with respect to the patient such that the power pack 114 is located away from the patient making the lamp system 100 easier to operate.

In one embodiment, the mast 110 may have a uniform outer dimension along its length, as shown in FIG. 1. In another embodiment, the mast 110 may have a non-uniform outer dimension along its length, as shown in FIG. 1a. In FIG. 1a, the mid-section of the mast 110 is of a larger dimension than other parts of the mast. In one aspect, this mid-section may coincide with the mounting position of the power pack 114. In another aspect, the wider portion of the mast 110 may be flattened to accommodate a power pack 114. In a third aspect, the wider portion may be sunken or recessed to accommodate a power pack 114 so that the power pack 114 does not protrude far from the general profile of the mast 110.

As shown in the embodiment of FIG. 1, the location of the power pack 114 on the mast 110 combined with the positionability of the lamp system 100 on either side of a patient enables both right-handed and left-handed lamp operators to operate the lamp system 100 equally comfortably and effectively.

The lamp head 110 is attached to a first end of a boom 103. The lamp head 110 is positionable with respect to the boom 103 and has a wide range of motion with respect to the end of the boom 103. The boom 103 is supported by a mast 110. In the illustrated embodiment, the boom 103 is pivotally mounted to the mast 110 at a point on the boom 103 distal to the lamp head 110.

The boom 103 is adjustably positionable with respect to the mast 101. The boom 103 has both a rotational and a tilt range of motion with respect to the mast 101. A counterweight 107 on the second end of the boom 103 provides a counterbalance for the lamp head 110. The mast 101 may be attached to a dental chair 80, as shown in FIGS. 1b and 1c. A separate power pack 114 may or may not be used in these embodiments.

In FIG. 1b, the illustrated dental apparatus 100″ is mounted or otherwise attached to the back portion of a dentist chair 80. FIG. 1b shows a perspective view of a dentist chair 80 which may include a mounted whitening apparatus 100″. The whitening apparatus 100″ may include a whitening lamp 110″ mounted on a boom arm 103″, which may further be mounted to mast 101″. The mast member 101″ may be permanently or reversibly mounted or otherwise attached to the dentist chair 80 about the, for example, the headrest or any other suitable component of the chair. The whitening apparatus 100″ may further include an adjustable hinge 98″ from which the whitening lamp 110″ may be allowed free rotation around a vertical axis from the boom arm 108″. The boom arm 103″ may be attached to the support member 101″ by means of an adjustable hinge 104″ from which the boom arm 103″ may, for example, swing up and down and be locked reversibly in position to aid in proper orientation of the whitening lamp 110″. The adjustable hinge 104″ may further include adjustment knobs 109″, 111″ which may be adapted to release or lock the boom arm 103″ from or in a particular position. The boom arm may further include features 105″ that may allow the boom arm to slide back and forth along its long axis to further aid in positioning the whitening lamp 110″. The boom arm may also include a handle 107″ distal to the whitening lamp 110″ to aid in handling the boom arm 103″ during adjustment and positioning. The handle 107″ may further be adapted to act as a counterweight to the whitening lamp 110″ to further aid in efficient and easy positioning of the whitening lamp 110″. The whitening lamp 110″ may also include a light guide 112″ that may be adapted to direct light toward the patient's teeth. The light guide 112″ may also include mounting features to interface with a lip retractor or other appropriate device, which may ensure proper positioning of the whitening lamp 110″ or curing light with respect to the patient's teeth, or in the case of therapeutic treatment, with respect to the oral cavity.

In FIG. 1c, the boom portion 103″ of the system 100″ is exemplified to be mounted to the arm of the dental chair 80.

The boom 103″ and mast 101″ may be fashioned out of any polymer or metal, such as those mentioned above for use in the lamp housing 113″. Here, since the boom 103″ and mast 101″ are less likely to be subjected to any potentially high temperature environment, the suitable materials need not be of high temperature resistance. On the other hand, structural integrity is a more desirable feature.

The dental chair 80 may have a base 112. The chair 80 may be rotatable with respect to the base 112.

In FIG. 1d, the illustrated dental apparatus 200″ is mounted or otherwise attached to the floor of a dental office. FIG. 1b shows a perspective view of a mounted whitening apparatus 200″. The whitening apparatus 200″ may include a whitening lamp 210″ mounted on a boom arm 203″, which may further be mounted to the mast 201″. The mast member 201″ may be permanently or reversibly mounted or otherwise attached to the floor of a dental office. The mast member 201″ may be attached with, for example, adjustable support members 201a″, 201b″, which may further be mounted to a stable mounting 201c″, as illustrated in FIG. 1d. The stable mounting 201c″ may be permanently or reversibly mounted or otherwise attached to the floor of the dental office and may provide stable support and a reference point for the rest of the whitening apparatus 200″. The vertical position of the whitening apparatus 200″ may be partially or wholly accomplished by adjustment of the adjustable support members 201a″ and 201b″. The adjustable support members 201a″, 201b″ may, for example, be substantially hollow and be slidably mounted to each other such that one may slide within or about the other for adjusting the vertical position of the attached components of the whitening apparatus 200″. The position may be stabilized between adjustments by a variety of means which may include, but are not limited to, friction fixing, locking and/or restraining components and/or any other appropriate means that may allow the position to be substantially maintained between adjustments. The whitening apparatus 200″ may further include an adjustable hinge 298″ from which the whitening lamp 210″ may be allowed free rotation about a vertical axis from the boom arm 208″. The boom arm 203″ may be attached to the support member 201″ by means of an adjustable hinge 204″ from which the boom arm 203″ may, for example, swing up and down and be locked reversibly in position to aid in proper orientation of the whitening lamp 210″. The adjustable hinge 204″ may further include adjustment knobs 209″, 211″ which may be adapted to release or lock the boom arm 203″ from or in a particular position. The boom arm may further include features 205″ that may allow the boom arm to slide back and forth along its long axis to further aid in positioning the whitening lamp 210″. The boom arm may also include a handle 207″ at the end distal to the whitening lamp 210″ to aid in handling the boom arm 203″ during adjustment and positioning. The handle 207″ may further be adapted to act as a counterweight to the whitening lamp 210″ to further aid in efficient and easy positioning of the whitening lamp 210″. The whitening lamp 210″ may also include a light guide 212″ that may be adapted to direct light toward the patient's teeth. The light guide 212″ may also include mounting features to interface with a lip retractor or other appropriate device, which may ensure proper positioning of the whitening lamp 210″ or curing light with respect to the patient's teeth, or in the case of therapeutic treatment, with respect to the oral cavity.

In FIG. 1e, the system 200″, which may be substantially identical to the system 200″ of FIG. 1d, is exemplified to be mounted to the ceiling of a dental office. In the case of FIG. 1e, the stable mounting 201c″ may be permanently or reversibly mounted or otherwise attached to the ceiling of the dental office and may provide stable support and a reference point for the rest of the whitening apparatus 200″ in a manner similar to the system 200″ of FIG. 1d.

In FIG. 1f, the system 200″, which may be substantially identical to the system 200″ of FIGS. 1d and 1e, is exemplified to be mounted to the wall of a dental office. In the case of FIG. 1f, the stable mounting 201c″ may be permanently or reversibly mounted or otherwise attached to the wall of the dental office and may provide stable support and a reference point for the rest of the whitening apparatus 200″ in a manner similar to the system 200″ of FIGS. 1d and 1e. In the case of FIG. 1f, the adjustable mounting members 201a″, 201b″ may be adapted to adjust the horizontal position of the whitening apparatus 200″ with respect to the stable mounting 201c″ attached to the wall of a dental office.

The boom 203″ and mast 201″ may be fashioned out of any polymer or metal, such as those mentioned above for use in the lamp housing 213″. Here, since the boom 203″ and mast 201″ are less likely to be subjected to any potentially high temperature environment, the suitable materials need not be of high temperature resistance. On the other hand, structural integrity is a more desirable feature.

The adjustable mounting members 201a″, 201b″ may be substantially rotatable about the stable mounting 201c″ such that the whitening apparatus 200″ may have more freedom of adjustment.

The stable mounting 201c″ may be attached to a surface by a variety of methods that may include, but are not limited to, bolts, screws, integral incorporation, inertial mounting (e.g. weighing down), and/or any other appropriate attachment method.

In some embodiments, the adjustable mounting members 201a″, 201b″ may be manually operated and adjusted. In other embodiments, the adjustable mounting members 201a″, 201b″ may be operated and adjusted with mechanical assistance. Mechanical assistance may include, for example, extension and/or retraction methods such as motorized, pneumatic, hydraulic, electromagnetic, or any other appropriate method.

Once the lamp system 100 is positioned with respect to the patient, the operator aligns the spacer, which is shown in FIG. 1 as a light guide 106, with the lamp system. The lamp head 102 may be set to a wide range of positions through the wide range of motion of both the boom 108 with respect to the mast 110 and the lamp head 102 with respect to the boom 108. The light guide 106 may be configured to mate with a lamp head 104, and a reference device, which may be a lip retracting device (not shown in FIG. 1 or 1a) worn by the patient, thereby providing a substantially precise alignment with the patient's mouth. Exemplary embodiments and materials are described in U.S. patent application Ser. No. 11/173,297, “Retracting Devices”, filed Jun. 30, 2005, the entire contents of which are hereby incorporated by reference.

The light guide 106 may also be made of similar materials as discussed above for the lamp housing 104 and lamp head 102. Additionally, like the lamp housing 104 and the lamp head 102, a cholesteric liquid crystal polymer, one that can reflect rather than transmit light energy, may be used either as a coating or as the main ingredient of the light guide to minimize escape of light energy, as described, for example, above.

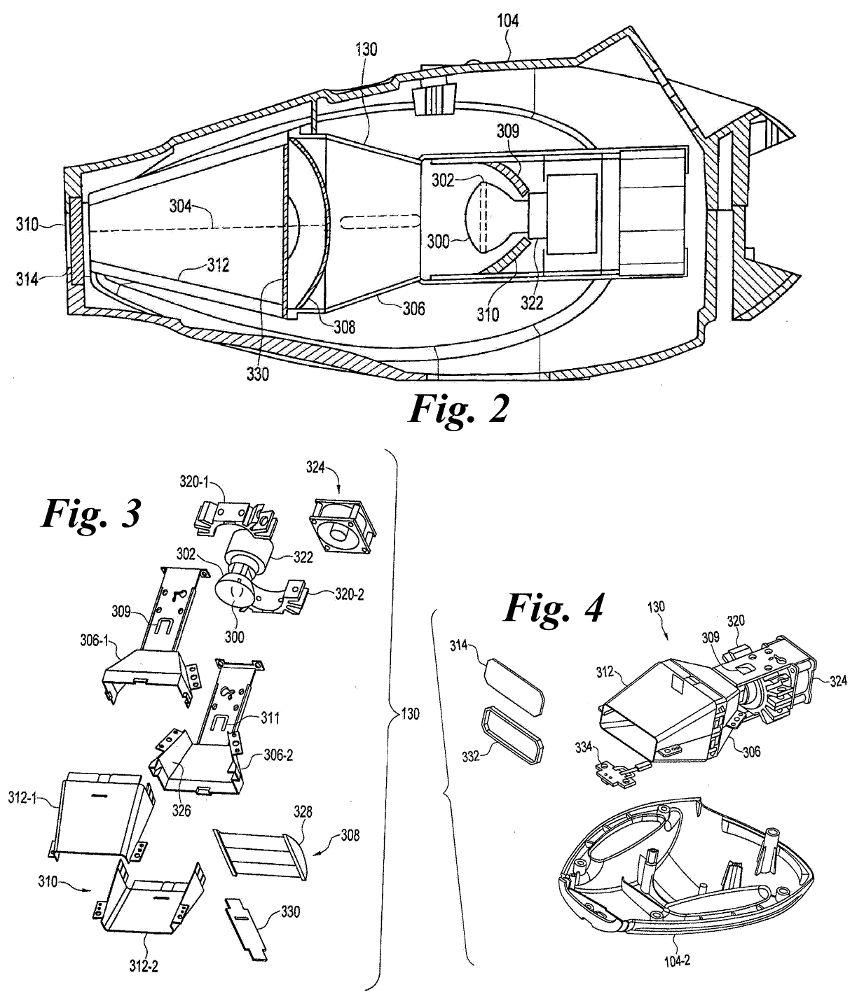

FIG. 2 shows, in cross section, various components of the lamp head housing 104 and lamp subassembly 130 according to one embodiment of the invention. A light source 300 located inside the lamp head housing 104 includes a first reflector 302 integral to the light source 300. The first reflector 302 directs light from the light source 300 generally along a path 304 through an aperture 310 in the lamp head housing to a target (not shown) such as a whitening compound disposed on a tooth surface or a filling compound residing either on the surface or in the cavity of a tooth.

The light path 304 includes a second reflector 306 generally coaxial with the first reflector 302. The body of the second reflector 306 includes an upper tab 309 and a lower tab 310 which are depressed after assembly toward the light source base 322. The upper tab 309 and lower tab 310 provide additional protection to hold the light source 300 in place if the lamp head 102 is jarred or dropped. The second reflector 306 includes a reflective internal surface adapted to further direct light toward the aperture 310 to the target. The present embodiment of the lamp head housing 104 further includes an optical lens 308 disposed within the second reflector 306. According to this embodiment, the optical lens 308 includes at least one curved surface and is adapted to direct light from the light source 300 toward the aperture 310.

The light path 304 further includes an integrator 312 located in proximity to the second reflector 306 and generally coaxial with the first reflector 302. The integrator 312 serves to integrate the light to provide light of uniform intensity passing through the aperture 310. The light path 304 further includes a diffuser 330 disposed within the integrator 312. In addition, an optical filter 314 disposed coincident with the second aperture 310 serves to impede the passage of various wavelengths of light while allowing the passage of other wavelengths. For example, in one embodiment, the optical filter 314 may serve to prevent passage of most light characterized as in the infrared range from passing through the second aperture 310 to the target. In contrast, light in the ultraviolet and/or visible ranges are allowed to pass. Consequently, light suitable for activating a dental whitening compound is available outside of the aperture 310, while infrared light, which would otherwise unduly elevate the temperature of the target area, is excluded from the target area or is reduced to acceptable levels.

The light source of the embodiment described above may also include a gas-filled arc light such as a halogen source, semiconductor light emitting devices, light emitting chips such as a light-emitting diode (LED), a solid-state LED, an LED array or a fluorescent light source, all of which are merely exemplary. Other types of light generation devices, including lasers and X-ray sources are possible within the scope of the invention.

FIG. 3 is an exploded view of a lamp head according to one embodiment of the invention. In the illustrated embodiment, a light source 300 includes a first reflector 302. The lamp subassembly 130 has a heat sink 320-1, 320-2 to be coupled to the light source ballast/base 322. A fan 324 located in the lamp head housing 104 in proximity to the heat sink 320 and ballast/base 322 further acts to keep the source 300 and lamp subassembly 130 cool. The heat sink may be made of any material that has good thermal conductivity, including metal blocks of copper, aluminum or similar. In another embodiment, the cooling system includes heat pipes. In another embodiment, the cooling system includes phase change materials, some embodiments and material are exemplified as is described in U.S. patent application Ser. No. 11/173,274, entitled “Dental Light Devices Having an Improved Heat Sink” filed on Jun. 30, 2005; and U.S. Provisional Application Ser. No. 60/585,224, entitled “Dental Light Devices With Phase Change Material Filled Heat Sink”, filed on Jul. 2, 2004, the contents of which are incorporated herein by reference.

The lamp subassembly 130 further includes a second reflector 306-1, 306-2 located substantially coaxial with the first reflector 302. The body of the second reflector 306 includes two tabs 309, 311. The tab 309 in the second reflector upper portion 306-1 is bent downwards toward the bulb base 322 which provide additional protection to hold the light source 300 in place if the lamp head 102 is jarred or dropped. In an alternative embodiment, the tab 311 in the second reflector lower portion 306-1 is bent upwards toward the bulb base 322 to provide further protection. Typically, only one of the tabs is bent in order to facilitate disassembly of the lamp head 102. The second reflector 306 includes a reflective internal surface 326 adapted to further direct light toward the aperture 310 to the target. The reflective internal surface 326 is, for example, a highly polished metal. Other embodiments of the second reflector 306 include anodized aluminum, and reflectors formed by vapor deposition of dielectric layers onto metallic layers, for example, a metallic layer on an anodized surface as the base reflection layer, followed by deposition of a low refractive index and then a high refractive index dielectric layer, such as those available from Alanod, Ltd. of the United Kingdom; a liquid crystal polymer plastic, one that can reflect rather than transmit light energy, may be used, either as a surface coating layer or as a main ingredient of the reflector, as described above, or other materials with similar properties.

Suitable liquid crystal polymers include those suitable for the lamp head housing mentioned above. Suitable polymers include a chiral polyester, polycarbonate, polyamide, polymethacrylate, polyacrylate, polysiloxane, or polyesterimide backbone that includes mesogenic groups optionally separated by rigid or flexible comonomers. Other suitable liquid crystal polymers have a polymer backbone (for example, a polyacrylate, polymethacrylate, polysiloxane, polyolefin, or polymalonate backbone) with chiral mesogenic side-chain groups. The side-chain groups are optionally separated from the backbone by a spacer, such as an alkylene or alkylene oxide spacer, to provide flexibility.

In one embodiment, an optical lens 308 is disposed within the second reflector 306. According to this embodiment, the optical lens 308 includes at least one curved surface and is adapted to direct light towards a target. The lamp subassembly 130 further includes the integrator 312-1, 312-2 and a diffusing element 330 which act together to provide uniform light directed at a target (not shown).

The optical path, or the interior of the lamp housing 104 of the lamp or illumination system may further include at least one absorber/emitter having at least a portion that is substantially transparent to the incident light, and at least one portion capable of absorbing the incident light and emitting light of a longer wavelength. In one embodiment, at least one wavelength transformer may be configured to capture substantially all the emitted light and transforming only a portion of the captured light into a longer wavelength. In another embodiment, at least one wavelength transformer may be configured to capture at least a portion of the light emitted by the light source and transforming all captured light into a longer wavelength. The wavelength transformer may also be present as a component of the light source 300, at least a portion or component of the reflectors 302, 306, or the interior of the lamp housing 104, as shown in FIG. 2.

The wavelength transformer may also be adapted to capture any lower wavelengths outside of the usable range of the intended purpose and transforming it to a usable wavelength, thus making use of the available output power and minimizing extraneous heat generation.

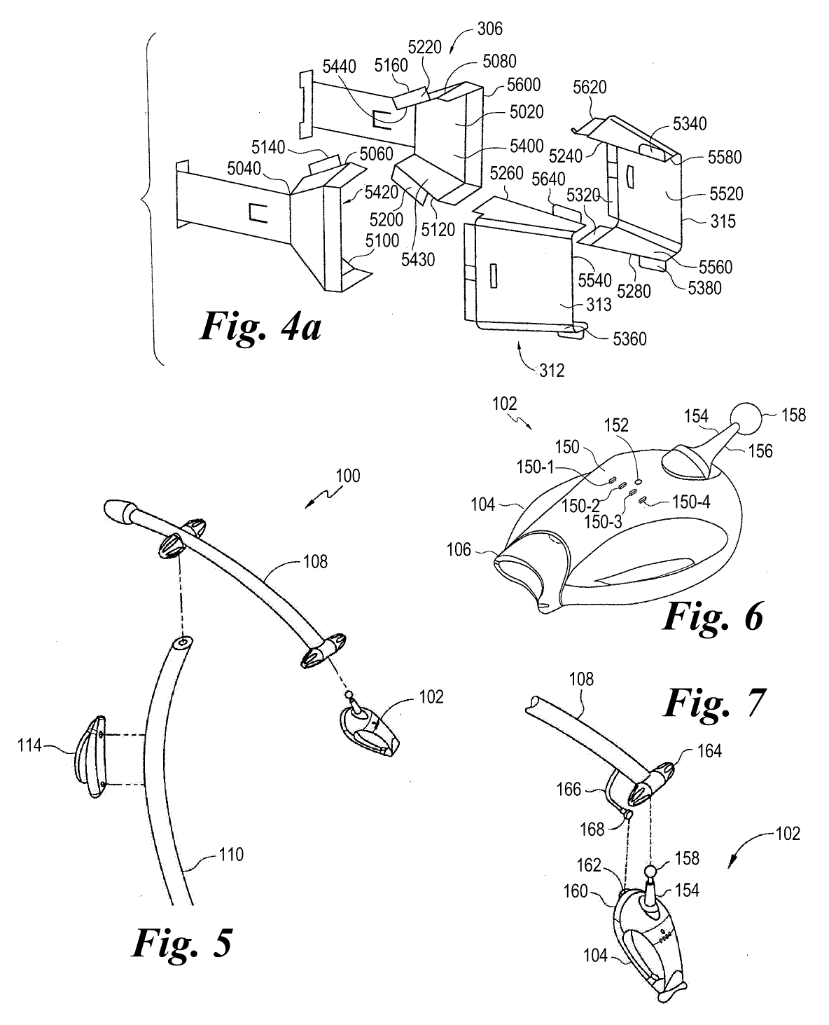

FIG. 4 is an exploded perspective view of the bottom half of the lamp head housing 104 and the lamp subassembly 130 of FIGS. 2 and 3. The lamp subassembly 130 is assembled in this view and includes the cooling components (the heat sink 320 and fan 324), and the second reflector 306 and integrator 312. The upper tab 309 in the second reflector 306 is shown in the depressed mode in order to protect the light source as described above. Further, the optical filter 314 is shown along with an elastomeric mounting 332 for the optical filter 314. When assembled into the lamp subassembly 130, the optical filter 314 is coupled to the integrator 312 with the elastomeric mounting 332. Also shown in this FIG. is the electromechanical connector 334 that couples the lamp system to the electronics in the light guide. This portion of the lamp system 100 will be described in greater detail below.

FIG. 4a shows the assembly of the second reflector 306 and integrator 312 in additional detail. According to the illustrated embodiment, the second reflector 306 and integrator 312 form a substantially rectangular pipe or box. As shown, the reflector includes first 5020 and second 5040 reflective internal surfaces.

In the illustrated embodiment, the lower portion 305 and upper portion 307 of the second reflector 306 are adapted to fit to one another at corresponding edges 5060, 5080 and 5100, 5120. According to one embodiment of the invention, the lower portion 305 and upper portion 307 each include respective tabs 5140, 5160, 5180 (not shown) and 5200 to facilitate this connection. Each tab 5140, 5160, 5180, 5200 includes a respective surface (e.g., 5220) adapted to be mutually supported against the respective tab of the opposing member.

Like the second reflector 306, the integrator 312 is formed, in the illustrated embodiment, of two portions 313 and 315. Each of these portions includes respective mutually supporting edges 5240, 5260, 5280 and 5300, and surfaces 5320, 5340, 5360 and 5380.

The reflector portions 5100, 5120 each have a substantially trapezoidal internal surface region 5400, 5420. In addition, the joining of the mutually supporting edges forms additional substantially trapezoidal surface regions 5430, 5440.

In like fashion, the integrator portions 313, 315 are joined during assembly. According to one embodiment of the invention, this results in substantially rectangular surface regions 5520, 5540 and substantially trapezoidal surface regions 5560, 5580. In another embodiment of the invention, surface regions 5520 and 5540 are substantially trapezoidal.

According to a further aspect of the invention, the reflector portions 5100, 5120 and integrator portions 313, 315 are joined at respective edges 5600, 5620 to form the above-mentioned substantially rectangular pipe or box. According to one embodiment of the invention, one or both of the reflector 306 and integrator 312 includes projecting tabs 5640 at their mutually supporting edges. These tabs 5640 may be integral to the respective assembly portions, or may be assembled thereto. According to one embodiment of the invention, the tabs 5640 serve to interleave with each other, or with the opposite member, and thus to more effectively couple the reflector 306 to the integrator 312.

Because the light wavelengths most effective for imaging, for chemical activation of a dental whitening compound or other dental composition, may be deleterious to soft tissues, it is desirable to minimize the exposure of a patients gums, tongue, facial skin and other soft tissues to the subject illumination. Therefore, properly controlling the light path and focus of the applied illumination is important.

In addition, in order to produce predictable, and therefore optimizable results, it is important that the intensity of the illumination received at a target composition be substantially spatially and uniform. Also, the above-noted desirability of limiting light exposure to the target composition motivates a further aspect of the invention in relation to fixturing of the light source and target area, also noted above.

FIG. 5 is an exploded perspective view of the lamp system according to one invention embodiment. According to various embodiments of the invention, the lamp head 102 is removably attached to the boom 108. The boom 108 is removably attached to the mast 110. In one embodiment, the mast 110 may be removably attached to the chair 80, to the floor, ceiling or wall, as noted above. The power pack 114 is removably attached to the mast 110. The attachment mechanisms for each piece will be described in greater detail below. The ability to separate each of the lamp system main elements, that is, the lamp head 102, the boom 108, the mast 110, and the power pack 114, from lamp system 100 provides advantages in shipping, transportation and maintenance.

The separated and/or modular lamp pieces are easier to pack in a shipping crate than the lamp system 100 assembled. Further, those pieces that require greater protection such as the lamp head 102 may be packed in a more protective container than the other pieces thereby protecting the more delicate pieces of the lamp system 100 while minimizing shipping costs.

The separated lamp system pieces are also easier to transport than a fully assembled lamp, as, for example, by a salesperson making customer visits. Further, the ability to separate the lamp system pieces enables individual pieces to be shipped to a repair center for repair or for upgrade. For example, the lamp head 102 may be shipped to a repair center for light source replacement.

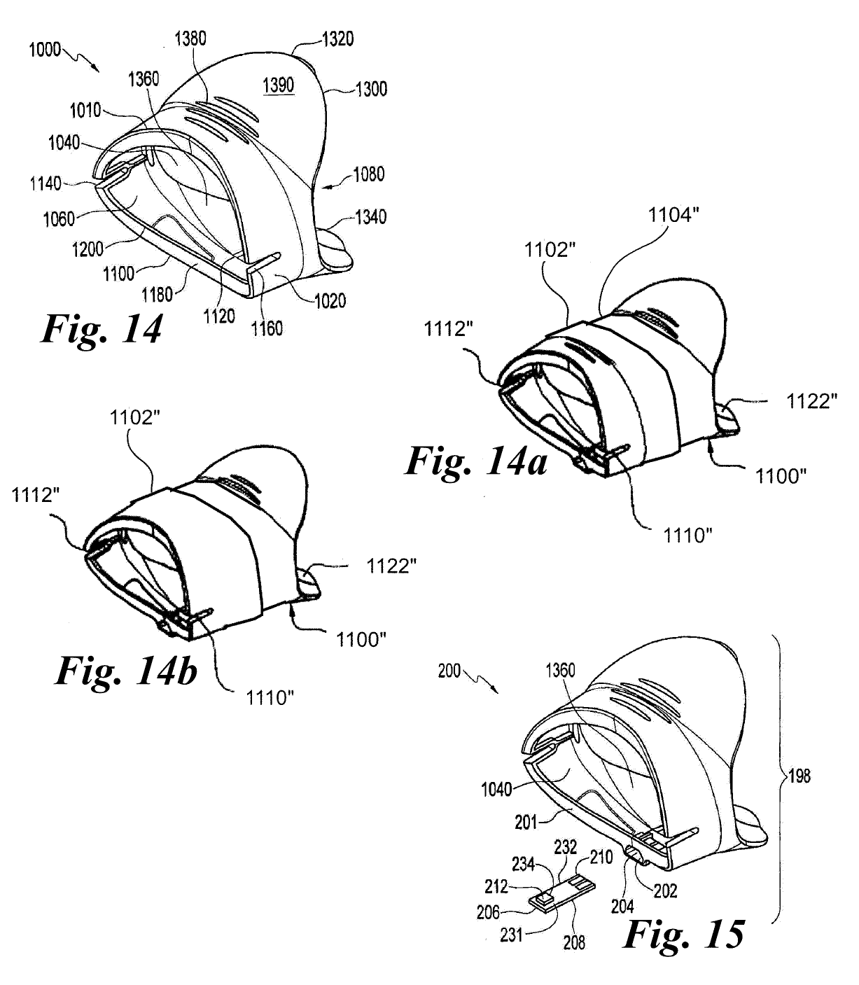

FIG. 6 is a perspective view of a lamp head 102 according to one embodiment of the invention. The lamp head 102 includes the lamp head housing 104 and the light guide 106. The lamp head housing 104 produces and directs light through the light guide 106. In the present embodiment, the lamp head housing 104 produces light with a light source such as a bulb or any of the light sources previously described. The light guide 106 may serve as an interface between the lamp system 100 and the patient having a dental treatment, such as whitening, to be described in greater detail below with regard to FIG. 14.

The lamp head housing 104 further includes two types of lighted indicators 150, 152. The first type 150 indicates the portion of the dental whitening process that has been completed. In this embodiment, there are four such lighted indicators 150-1, 150-2, 150-3, and 150-4. Each of these indicators 150-1, 150-2, 150-3, and 150-4 shows that a portion of the whitening process has been completed. For example, for an hour-long whitening process, a first 150-1 of these indicators is lit after fifteen minutes. After thirty minutes a second indicator 150-2 is lit, and so on until the hour is passed at which point all indicators 150-1, 150-2, 150-3, and 150-4 are lit. In an alternative embodiment of the invention, the lamp head housing 104 includes an indicator system in which a lighted indicator blinks at selected intervals to indicate the percentage of the whitening process that has been completed. In another alternative embodiment of the invention, a display mounted in the lamp head housing 104, such as a liquid crystal display, indicates the status of the whitening process.

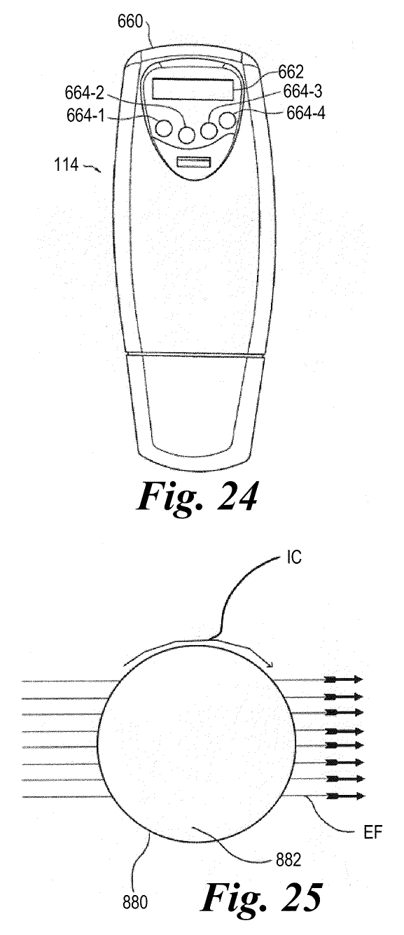

The second type of lighted indicator is a single indicator 152 that indicates a need for a new light source in the lamp head housing 104, hereafter referred to as the light source replacement indicator 152. The mechanism by which the light source replacement indicator 152 is activated will be described below with respect to FIG. 24.

In the illustrated embodiment of the lamp head housing 104, the lighted indicators 150, 152 are lit with LEDs. In a first alternative embodiment, the LEDs protrude through the surface of the lamp head housing 104. In a second alternative embodiment, the top surface of the lamp head housing 104 may be sealed and/or smooth and the LEDs are positioned in recesses in the undersurface of the lamp head housing 104. The material of the lamp head housing 104 in the vicinity of the LED may be transparent or translucent. This embodiment has the advantage that the surface of the lamp head housing 104 is easier to clean and also does not collect debris as would occur if there were protrusions in the lamp head housing surface. In a third alternative embodiment, the lamp head housing surface has markings positioned over the lighted indicators of the second embodiment.

In another embodiment of the invention, a control system having a built-in voice alert system for alerting a dental professional of the time, or stage, in a dental procedure may be included. The control system may also include a headphone or other private listening device, for example, so that only the dental professional will receive the voice alert. In one aspect, the private listening device may be a wireless listening device such as a wireless radio channeling device or an infrared channeling device.

In one embodiment, a dental light system includes a built-in electronic voice alerting system to alert the dental professional of the completion of a dental procedure.

In one aspect, the electronic voice alerting system may utilize an electronic voice generating circuit technology, similar to the technology used in electronic devices such as toys, cell phones, automobiles and other consumer electronics, but with novel message content that is directed to dental applications.

In still another embodiment, a dental illumination system includes an audible electronic voice alert system having a novel approach to tracking time during the above mentioned dental procedures and other similar dental procedures. This audible electronic voice alert system uses an electronic device with prerecorded time interval statements stored in the device.

According to one embodiment, the alert system, in addition to having the lighted indicators mentioned above, is also adapted to play a recorded voice that is generated when an electronic timer circuit is programmed to play the appropriate electronic voice count alert through an audio speaker in the device. In one aspect, the message played may include time intervals, and may be programmed and in some embodiments, re-programmed. Exemplary embodiments and examples of voice alert systems are described in U.S. patent application Ser. No. 11/175,693, filed Jul. 5, 2005, the entire contents of which are herein incorporated by reference.

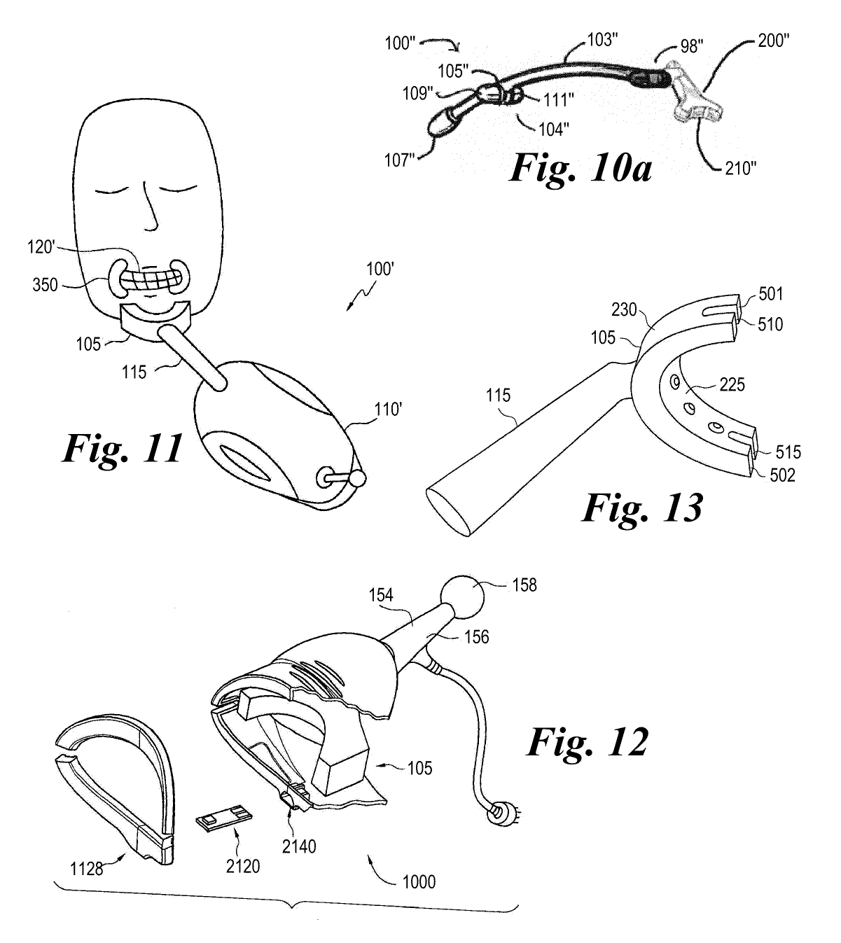

The present embodiment of the lamp head 102 further includes a formation such as a pivot mount 154. This pivot mount is also used if an illumination frame 105, such as that shown in FIG. 10 described below, is used in place of the lamp head 102. The pivot mount 154 is used to removably attach the lamp head 102 to the boom 108. The pivot mount 154 includes a shaft 156 and a ball swivel 158. The shaft 156 of the pivot mount 154 is attached at one end to the back of the lamp head housing 104. The ball swivel 158 is attached to the other end of the shaft 156. The ball swivel 158 is inserted into a spring-loaded ball cup on the boom 108 which will be described in greater detail below with regard to FIG. 5. The pivot mount 154 enables the lamp head 102 to be swiveled around the end of the boom 108 resulting in a high degree of freedom of movement and therefore also improved ability to position the lamp head 102 with respect to the patient.

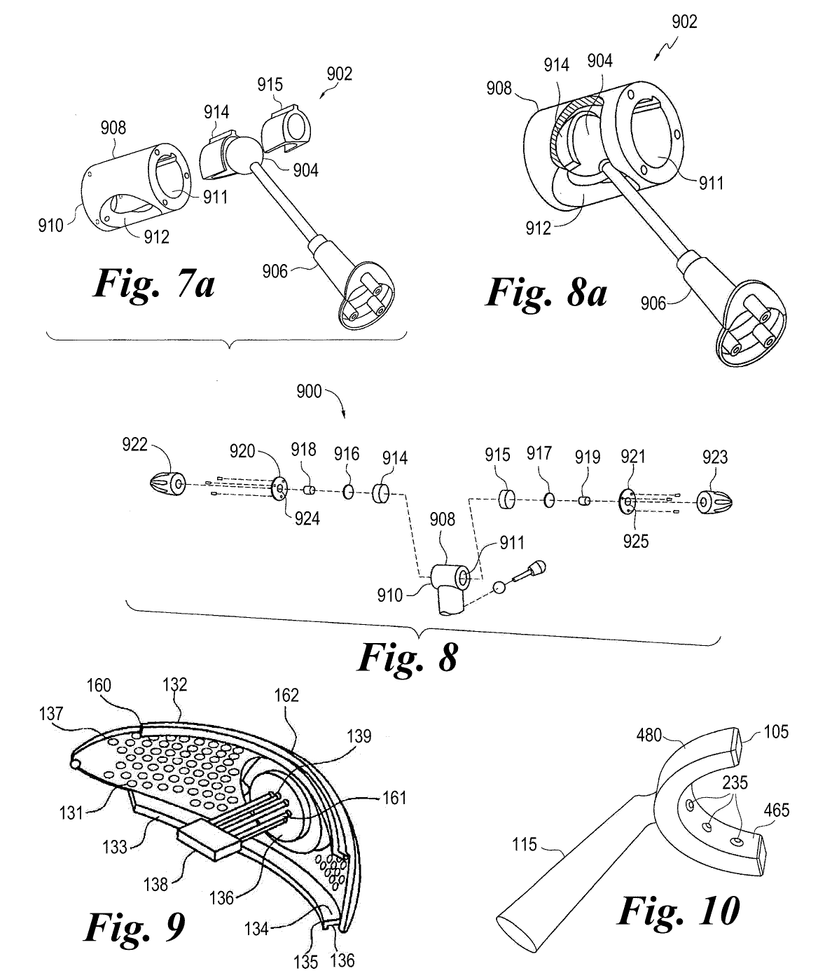

FIG. 7 is a perspective view of the lamp head 102 and a portion of the boom 108, further illustrating the removability of the lamp head 102 from the boom 108. The lamp head 102 is shown separated from the end of the boom 108, and includes the lamp head housing 104 and the pivot mount 154. At the rear of the lamp head housing 104 is a grill 160 having an electrical connector 162.

The boom 108 has a lamp connector assembly 164. The lamp connector assembly 164 receives the ball swivel 158 of the pivot mount thereby removably attaching the lamp head 102 to the boom 108. As described above, this connection between the lamp head 102 and the boom 108 allows a high degree of freedom of movement of the lamp head 102 with respect to the boom 108. Further, the boom 108 is a substantially hollow tube and may contain I/O cables 166. The I/O cables 166 include an electrical plug 168 that is received by the electrical connector 162 in the lamp head housing 104 thereby removably attaching the lamp head 102 to the boom electronically. The I/O cables 166 provide power to the lamp head 102 and also carry data and control signals to and from the power pack 114.

FIG. 7a shows, in perspective view, components of a ball and socket joint according to one embodiment of the invention. The ball and socket joint (also referred to as a ball joint) 902 includes a head tube 908 having a first opening 910 and a second opening 911 at opposite ends of the head tube 908. A third opening 912 is present in the side of the head tube 908. The ball joint 902 further includes a first ball cup 914 and a second ball cup 915 to be received into the first and second openings 910, 911, respectively. A pivot mount 906 that holds the dental whitening lamp head (not shown) connects to the ball joint 902 by a ball swivel 904. The first and second ball cups 914, 915 are configured to receive the ball swivel 904 through the third opening 912 in the head tube 908. The ball joint 902 will be described in more detail below.

FIG. 8 is an exploded view of the lamp connector assembly 900 enabling separable attachment between the lamp head 102 (not shown here) and the boom 103. The head tube 908 is attached to the end of the boom 103. The lamp connector assembly 900 is a socket joint including a ball joint 902 that receives the ball swivel 904 of pivot mount 906 on the lamp head as shown below.

The forward assembly 900 of the present embodiment includes a first and a second ball cup 914, 915, a first and a second spacer 916, 917, a first and a second spring 918, 919, a first and a second nut plate 920, 921 and a first and a second ball joint knob 922, 923. Each ball cup 914, 915 has a curved surface so that when the ball cups 914, 915 are mated at the curved surfaces a substantially spherically-shaped space configured to receive the ball swivel 904 is formed.

To form the ball joint, the ball cups 914, 915 are inserted into the head tube 908 so that the spherically-shaped space aligns with the third opening 912 of the head tube 908. The spacers 916, 917 are inserted into openings 910 and 911 respectively and positioned on either side of the mated ball cups 914, 915. The first and second springs 918, 919 are placed against the first and second spacers 916, 917 respectively.

The nut plates 920, 921 are attached on opposing ends of the head tube 908 over the first and second openings 910, 911. The nut plates 920, 921 each may have a central opening 918, 919 that may be threaded.

According to one embodiment of the invention, each of the knobs 922, 923 may include an ultrasonically welded stud having an externally threaded distal end. The screws of the knobs 922, 923 are screwed through the central openings of the nut plates 920, 921 and press against the springs 918, 919, spacers 916, 917, and ball cups 914, 915 to press the ball cups 914, 915 against the ball swivel 904. When the knobs 922, 923 are tightened down, the received ball swivel 904 may not move inside the mated ball cups 914, 915. When the knobs 922, 923 are loosened, the received ball swivel 904 may move inside the mated ball cups 914, 915.

A first alternative embodiment of the ball socket involves relying on spring strength rather than pressure from a screw to put pressure against the ball cups 914, 915. Further, the springs 918, 919 shown here are coil springs. Alternatives to coil springs include, for example, spring washers, and other mechanisms for applying linear force, as known to those of skill in the art.

FIG. 8a shows, in sectional perspective view, components of a ball joint 902 shown with a cutaway view of the head tube 908 according to one embodiment of the invention. The first ball cup 914 is in place inside the head tube 908. The ball swivel 904 of the pivot mount 906 is shown inserted through the third opening 912 of the head tube 908.

One of skill in the art will appreciate that a ball joint, such as that illustrated, for example, in above FIGS. 8 and 8a, is merely exemplary of the various formations or coupling features which may be used to couple a dental apparatus or device to an end of the boom 903. For example in an alternative embodiment a flexible member, such as a gooseneck member, is disposed between the payload apparatus and the anterior end of the boom. The support structure of invention may include any flexible coupling device appropriate to a particular application and payload apparatus.

FIG. 9 shows, in perspective view, a grill 160 for a lamp head housing according to one embodiment of the invention. In the illustrated embodiment, the grill includes a plurality of perforations 131 between inner and outer surfaces thereof. The perforations 131 are adapted to permit the passage of ambient air between an interior region and an exterior region of the lamp head housing, and thus allow for cooling and ventilation of the housing. In one embodiment, the perforations include a plurality of substantially circular holes. In other embodiments, the grill may include square holes, rectangular holes or slots, louvers, or another appropriate perforated barrier such as, for example, a woven wire screen or appropriate textile material.

The grill of the illustrated embodiment includes two flanges adapted to retain the grill in a substantially fixed position at an aperture of the lamp head housing. In the embodiment shown, the flanges include an upper flange 132 and a lower flange 133. Each flange has a respective first lateral 134 and second elevated 135 portions disposed in angled relation to one another.

The angled relation between lateral 134 and elevated 135 flange portions includes, in various embodiments, a 90° angle or other angle suited to a particular application. In addition, the flange of a particular embodiment includes a barb or latching profile or feature.

As would be understood by one of skill in the art, the elevated portions 135 include respective surfaces 136 adapted to contact respective inwardly facing regions of the lamp head housing so as to prevent displacement of the grill 160 when in use. Although the illustrated embodiment includes flanges that contiguously span a substantial portion of a width of the grill alternative embodiments include a plurality of narrower flanges spaced about a perimeter 137 of the grill.

It will be appreciated that, in various embodiments, the flanges may be supplemented or replaced by alternative coupling features such as snaps or fasteners. According to particular embodiments, such snaps or fasteners include one or more rivets, including pop-rivets, machine screws, self tapping screws, ball and socket pins, roll pins and cotter pins. In other embodiments, the grill is fixed in place by application of a chemical adhesive such as, for example, epoxy, silicone adhesive, contact cement, or cyanoacrylate based adhesive. In still other embodiments of the invention, the grill is retained in position by an elastomeric gasket and/or a magnetic coupler.

According to the illustrated embodiment, the grill also includes an electrical connector 162. The electrical connector has a reinforced region 138. In the illustrated embodiment, the reinforced region 138 is a removable member that is adapted to be assembled to the balance of the grill. In another embodiment of the invention, the reinforced region is integrally formed as a portion of the grill.

In one embodiment, the reinforced region 138 supports a plurality of individual electrical connector pins 139. In various embodiments the individual electrical connector pins include crimp-on connector pins such as, for example Molex connector pins. In another embodiment of the invention, the individual connector pins are adapted to be soldered to respective conductors, or integrally formed with those respective conductors.

In one embodiment of the invention, one or more of the individual connector pins is a female receptacle. In another embodiment of the invention, one or more of the individual connector pins is a male plug. One of skill in the art will appreciate that a wide variety of alternative integrated and individual connectors are possible, including connectors not available at the time of conception, and that these various connectors fall within the scope of the invention.

According to one embodiment of the invention, the individual connector pins are adapted to be inserted into pre-formed bores within the reinforced region 138. In another embodiment of the invention, the reinforced region is adapted to be formed, as for example by injection molding, with the individual connector pins 139 molded in situ.

In the illustrated embodiment, each connector is coupled to a respective conductor 161 so as to form respective mechanical and electrical connections to the conductor 161. According to one aspect of the invention, as illustrated, the respective conductors are mutually coupled to a second electrical connector 163 that is adapted to be disposed within the lamp housing. The second electrical connector includes a plurality of electrical contacts for connection to, for example, an internal circuit board of the lamp head.

Multiple light sources, as shown in FIG. 10, may be used in place of the above lamp head housing as a self-contained structure, for example, an illumination frame, 105, in one embodiment. In a further aspect, the illumination frame may be in addition to the lamp head housing, as shown in FIG. 11. In another embodiment of the invention, the illumination frame may be mounted to a lamp head, as is also shown in FIG. 11. The dental illumination system 100′ includes an illumination frame 105 connected to a lamp head 110′ by a tube 115. The illumination frame 105 provides light to activate a whitening substance or curing composite applied to a patient's teeth 120. The patient typically wears a reference device, such as a lip retracting device 350. The illumination frame 105 and lamp head 110′ together generate and direct light toward the patient's teeth 120′ for a whitening or a curing process. In one alternative embodiment, the illumination frame 105 and tube 115 may be adjustable with respect to the lamp head 110′. In another alternative embodiment, the tube 115 is flexible and may be adjusted to various positions. In another embodiment, the illumination frame 110′ is flexible.

In the illumination system with multiple light sources, the light sources may be collectively powered or individually powered. If individually powered, each of the individual light sources may be turned on or off separately, as desired. This is especially useful for a curing or imaging process, where only one or two teeth may be undergoing treatment or being examined.

Multiple light sources may be arranged in a geometric arrangement. In one embodiment, they may be arranged in an arcuate form and may, for example, conform to the jaw of a patient, as shown in FIG. 10. The illumination frame 105 has a front 465 and a back 460. The front 465 is concave and the back 460 is convex. The tube 115 is attached to the back 230 of the illumination frame 105. The tube 115 provides support for the illumination frame 105 and also acts as a conduit for wiring for the illumination frame 105. A plurality of light sources 235 is arranged along the front 465 of the illumination frame 105. The light sources may be any light source as described above. These light sources are merely exemplary and are not limited to those listed. The light sources 235 generate and direct light toward the patient's teeth (as shown in FIG. 11) for a whitening, imaging or a curing process. In a first embodiment, the light sources 235 emit light having substantially the same light spectrum. In a second embodiment, the light sources 235 emit light having different spectra. In one aspect, the light sources are approximately equidistant from the various teeth toward which the light sources are directed. In another aspect, the light sources 235 may protrude from the surface of the front 460 of the illumination frame 105. In a further aspect, the light sources 235 may be disposed substantially flush with the surface of the front 460 of the illumination frame 105.

In some embodiments, multiple light sources may be included to allow different intensities and distributions of electromagnetic radiation to be applied. In one aspect, light sources may be arranged in discrete arrays that may be powered and operated individually. The different arrays may include different types of light sources that may, for example, emit different spectra of electromagnetic radiation and/or may emit increased or decreased intensities of certain wavelengths of electromagnetic radiation. An example may be an array of sources that may emit more ultraviolet radiation while another array may emit less ultraviolet radiation. Such embodiments may be useful in adapting a single light source to different dental applications by varying which array of sources is in use. These embodiments also apply to other lamp systems discussed above.

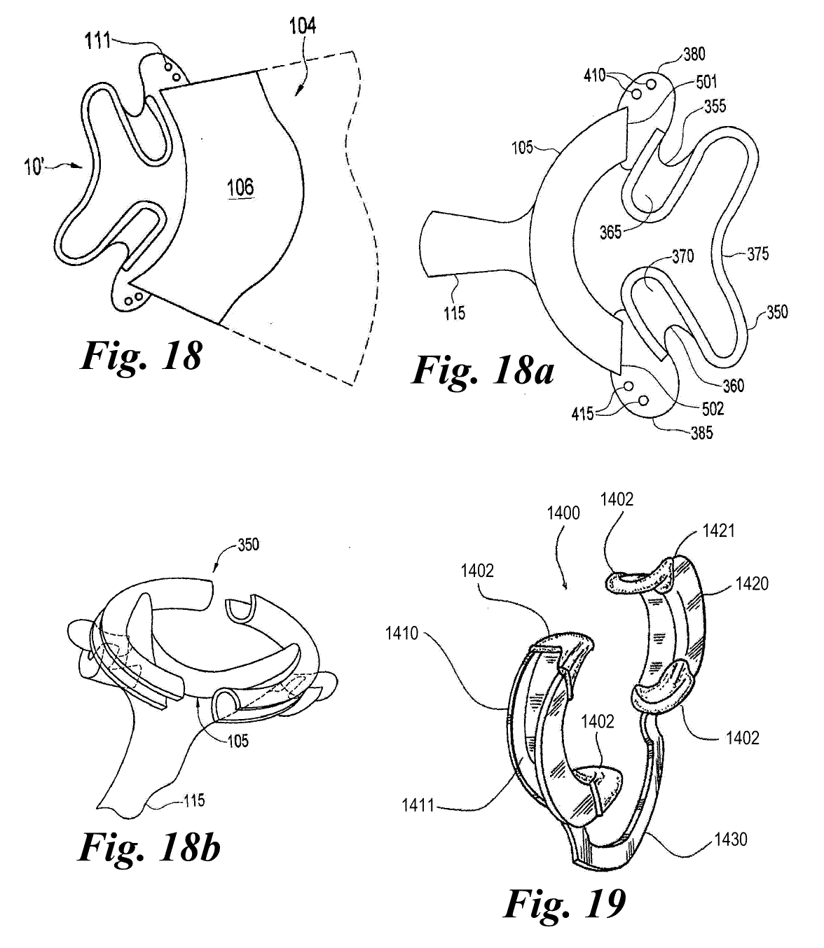

In other embodiments of the invention, the illumination frame 105 may be shaped and configured to mate with a reference device such as a lip retracting device worn by the patient, such as shown in FIGS. 18a and 18b, thereby providing a substantially precise alignment with the patient's mouth.

FIG. 10a is perspective view of an illumination frame attached to a support system in another embodiment of the invention. The illumination frame 115″ may be adapted to provide light from a plurality of light emitting faces or surfaces 117″ that may be angled in an arcuate manner such that they may provide better coverage of patient's teeth. The illumination frame 115″ may include any appropriate number of angled faces or surfaces 117″ such that it may provide better coverage of the patient's teeth. In general, an increased number of faces or surfaces may allow the illumination frame 115″ to better resemble the arcuate shape of a patient's jaws and thus may provide better coverage of the patient's teeth. However, it may be observed that a relatively small number of faces or surfaces may be adequate in providing the necessary contour and coverage of a patient's teeth for a whitening procedure.

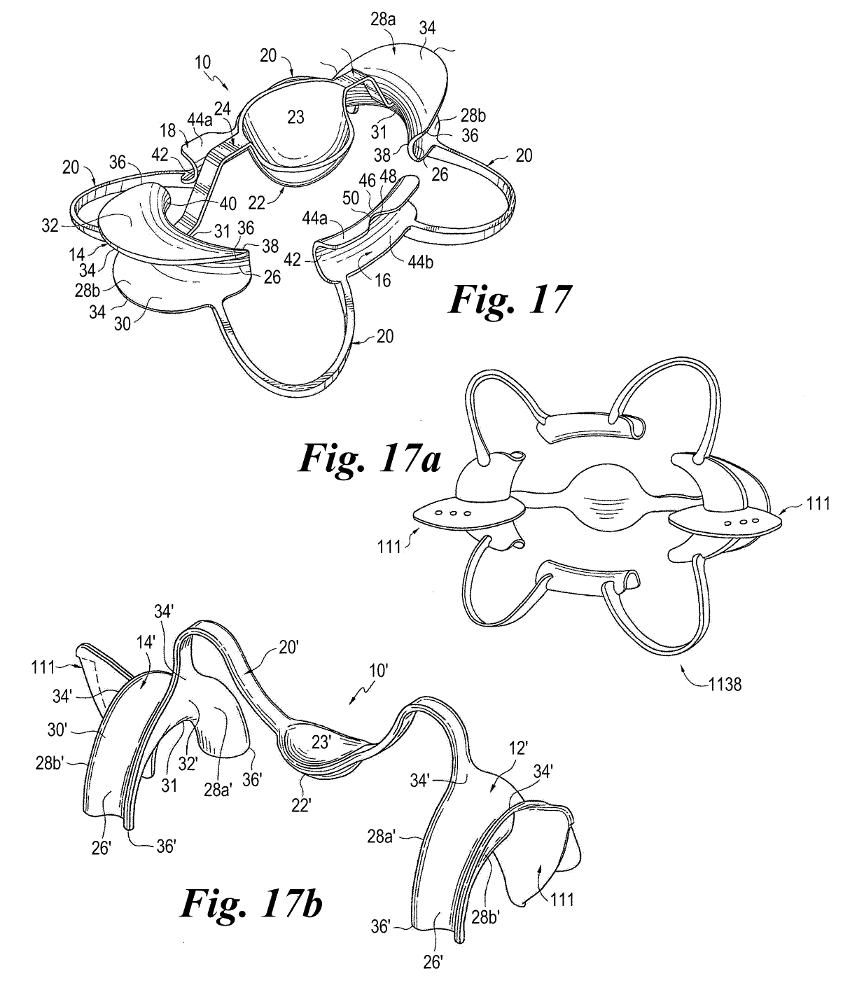

In some exemplary embodiments, for example, FIG. 12, the illumination frame 105 may be attached to or disposed inside a spacer, such as a light guide 106, having formations, such as slots for engaging with a reference device, such as a lip retracting device 1138, as shown in FIGS. 17a and b, also having formations, such as wing-like members 111, for positioning the illumination frame 105. An elastic member 1128 is disposed between the patient and the light guide 106. The elastic member 1128 serves to cushion the interface between the patient and the light guide 106, absorbing shocks which might otherwise be painful or uncomfortable.

In another aspect, the illumination frame 105 may be a self-contained structure, such as shown in FIGS. 10, 12 and 13. In FIG. 13, the illumination frame 105 has a generally arcuate shape having a first end 501 and a second end 502. The back 230 of the illumination frame 105 is convex and the front 225 of the illumination frame 105 is concave. The illumination frame 105 may also serve as the spacer having formations. In other words, the spacer and formations, for example, slots, may both be present on the lamp housing, such as the illumination frame 105, as exemplified in FIG. 18b. The ends 500, 505 each has a slot 510, 515 open from the front 225 of the illumination frame 105 towards the back 230 of the illumination frame 105. Each slot 510, 515, extends inwardly from its respective end 501, 502 of the illumination frame 105. The slots 510, 515 are located and configured to mate with the formations of a reference device, such as the wings 111 of a lip retracting device 1138, as shown in FIGS. 17a and b.

The light sources of the illumination frame 105 may be of one wavelength, or may be of different wavelengths, as mentioned above.

In another embodiment, the illumination frame 105, such as that exemplified in FIG. 12, may be attached to the support system of FIG. 1. As noted above, the boom 108 is adjustably positionable with respect to the mast 110. The boom 108 has both a rotational and a tilt range of motion with respect to the mast 110. A counterweight 122 on the second end of the boom 108 provides a counterbalance for the illumination frame 105.

As noted above, the spacer may be a light guide 1000, as shown in FIG. 14, which includes an elliptically tubular member 1020 having an axial cavity 1040 disposed between a front aperture 1060 and a rear aperture 1080.

As shown in the illustrated embodiment, a first edge 1010 of the tubular member defines a substantially elliptically saddle shaped curve having a convex form in relation to a generally horizontal portion 1100 thereof and a concave form in relation to a generally vertical portion 1120 thereof. In addition, edge 1010 includes first and second substantially horizontal slots 1140, 1160. According to one embodiment of the invention, the slots 1140, 1160 are disposed substantially coplanar with respect to one another and are disposed substantially coincident with a major axis of the elliptically saddle shaped curve that defines edge 1010.

A rim 1180 extends radially inwardly from the edge 1010 to a second substantially elliptically saddle shaped curved edge 1200 (also referred to as the “second edge”). The second edge 1200 is disposed in substantially constant spatial relation to edge 1010, whereby the rim 1180 has a substantially uniform radial dimension over the length of edge 1010. Edge 1200 defines an outer periphery of the front aperture 1060.

At the rear end of the embodiment of FIG. 14, a third edge 1300 defines another curve that is of an approximately elliptically saddle shape. Edge 1300 is substantially concave in form in relation to a generally horizontal portion 1320 thereof and is generally convex in form in relation to a generally vertical portion 1340 thereof.

According to one embodiment of the invention, curve 1300 defines the rear aperture 1080 of the light guide.

According to one embodiment of the invention, the light guide does not include a rim adjacent the rear aperture 1080.

In one aspect of the illustrated embodiment, an outer surface 1390 of the light guide is disposed between edge 1010 and edge 1300. An inner surface 1360 of the light guide is disposed in a substantially uniform spatial relation to outer surface 1390 so as to define inward and outward boundaries of the elliptically tubular member 1020.

In one embodiment of the invention, outer surface 1390 includes a plurality of gripping features 1380 adapted to improve the grip of an operator on surface 1390 during manipulation of the light guide 1000. In the illustrated embodiment, the gripping features 1380 have a raised elongated ellipsoid aspect. In another embodiment of the invention, the gripping features include a plurality of substantially hemispherical bumps. In still another embodiment of the invention, the gripping features include a plurality of zigzag grooves. One of skill in the art will appreciate that a wide variety of features may be disposed on surface 1340, so as to enhance overall gripability of the light guide 1000.

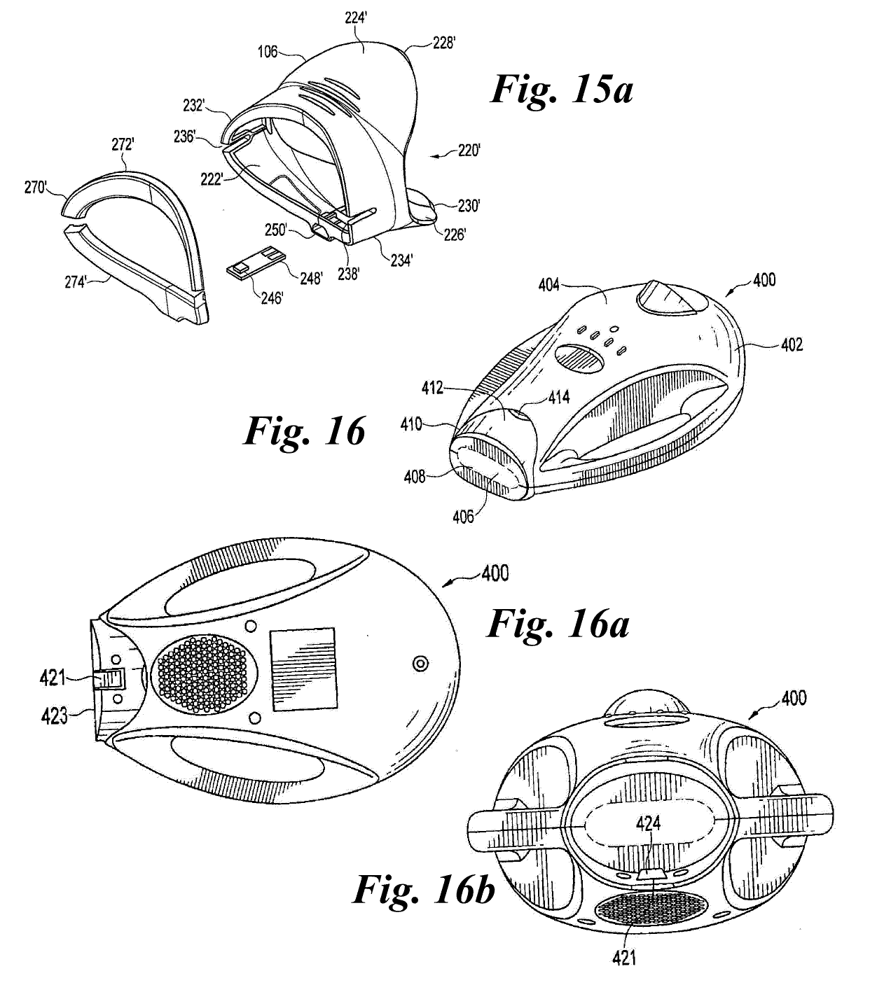

FIG. 15 shows a light guide 200 according to another embodiment of the invention. The light guide 200 includes a rim 201 with an aperture 202 in a lower portion thereof. The aperture 202 opens inwardly from a front end of the light guide 200 into an elongated cavity 204 formed, in part, by the inner wall 1360 of the light guide. According to one embodiment of the invention, the cavity 204 is adapted to receive a recording device 206 therein.

According to one embodiment of the invention, the recording device 206 includes an assembly having a printed circuit board 208 with an electromechanical contact 210 and a memory integrated circuit 212 disposed thereon. In one aspect, the recording device 206 includes a first side 231 and a second side 232. In the illustrated embodiment, the memory integrated circuit 212 has a rear side 234. Pursuant to one embodiment of the invention, the memory integrated circuit 212 is substantially permanently fixed to the circuit board by, for example, soldering, adhesive bonding, potting or other methods for integrated circuit mounting as are known to those of ordinary skill in the art.

According to one embodiment of the invention, the cavity 204 is defined by a plurality of surfaces, adapted to support the recording device 206 substantially fixedly with respect to the light guide 200.

In one embodiment of the invention, the recording device 206 is supported in a position such that the electromechanical contact 210 is disposed in an elevated and exposed location within axial cavity 1040 of the light guide 200.

This spatial relationship is shown more clearly in, for example, FIG. 18 which shows a posterior perspective view of a light guide 3000 having disposed on the internal surface 1360a first support member 3020 and a second support member 3040. Support member 3020 includes a first bearing wall 3060 and support member 3040 includes a second bearing wall 3080. A third support member 3100 includes a bearing top surface 3120.

Turning once again to recording device 206 (as shown in FIG. 15) one sees that recording device 206 is adapted to be received within a region 3200 as shown in FIG. 18. When recording device 206 is disposed in region 3200, bearing surface 3060 is disposed adjacent to and supports edge 231. The bearing surface 3080 is disposed adjacent to and supports edge 232 and bearing surface 3120 is disposed adjacent to and supports an underside surface (not shown) of recording device 206.

As a further feature of light guide 3000, a surface 3300 is disposed in a generally vertical orientation. A further surface is disposed in substantially parallel spatial relation to surface 3300, and forwardly of the same.

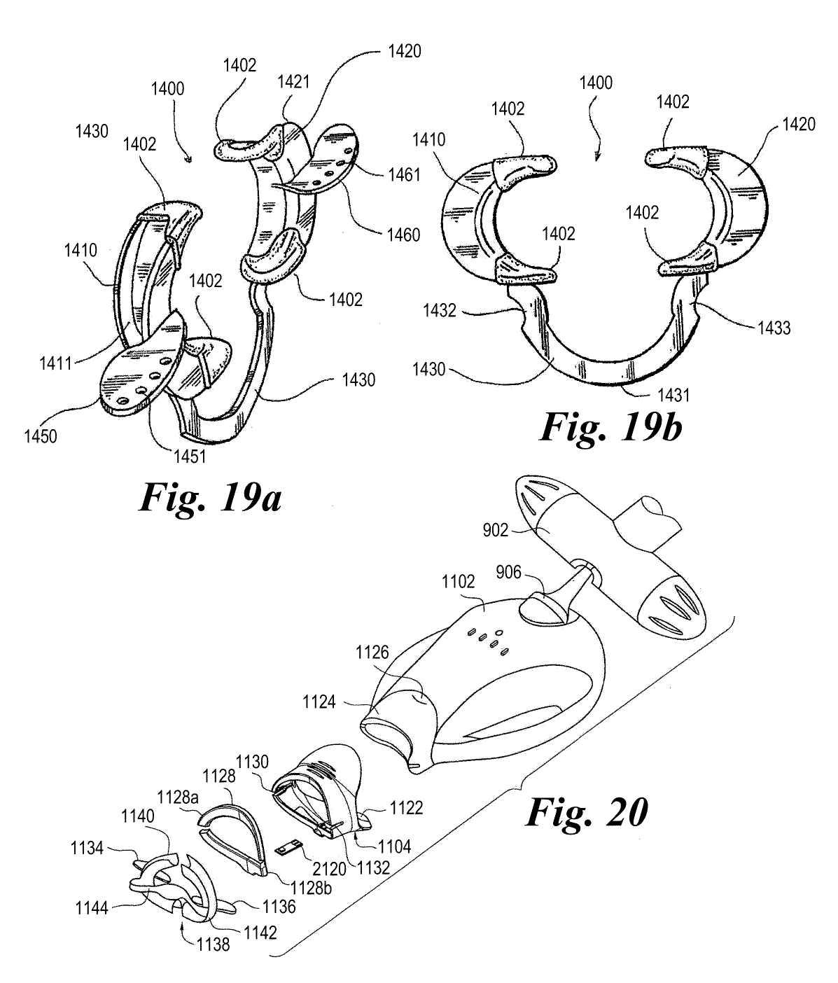

Further insight into recording device 206 and its role in the invention is gained by reference to FIG. 19 which shows a light guide 3500 according to one embodiment of the invention in anterior elevation. Specifically, FIG. 19 shows the further bearing surface 3320 disposed in substantially parallel spatial relation to surface 3300 (as shown in FIG. 18) as discussed immediately above. Also shown are aperture 202 (as discussed above in relation to FIG. 15), first bearing wall 3080 and second bearing wall 3060 (as discussed above in relation to FIG. 18).

FIG. 15a shows another embodiment of the light guide 106 of a generally ellipsoidal shape having a first opening 220′ at one end that attaches to the lamp head housing 104 and a second opening 222′ at the other end that interfaces with the patient. The first opening 220′ has extended edges 224′, 226′ that extend substantially parallel to the long diameter of the oval formed by the light guide 106.

The extended edges 224′, 226′ form a curved interface configured to mate with the lamp head housing 104. The light guide 106 mechanically couples to the lamp head housing 104. A first protrusion 228′ on extended edge 224′ and a second protrusion 230′ on extended edge 226′ are configured to mate with indentations on the lamp head 102 and act to hold the light guide 106 to the lamp head housing 104. A first slot 236′ and a second slot 238′ on opposing sides of the second opening 222′ of the light guide 106 may be configured to mate with a reference device, such as a lip retracting device 1148, worn by the patient as illustrated in FIGS. 17b and 17a described below to align the lamp head 102 accurately with the patient.

In one aspect, the light guide may include other formations for varying the distance between the light source and the target. These formations may be simple length extensions or contractions of the light guide body, so that the distance between the light source and the target, for example, the surface of a patient's teeth, may be varied by varying the length of the light guide body. Since the intensity of light varies as the inverse cube of distance from a light source, the formations may serve as a control of the actual power density received at the target. Thus, the light guide having a particular length maybe used to substantially set the effective light intensity delivered to the target during a procedure. The length extensions or contractions may be integral to the light guide or may be attached to the light guide. The extension or contraction may be telescopic or coextensive with features adapted for holding a fixed length once the length is determined. These features may include, for example, a clip, an extension rod or so on.

FIG. 14a illustrates an embodiment of a light guide 1100″ that may include formations that may allow it to extend and/or contract its length. The light guide 1100″ may include inner surface area 1122″ that may be adapted to be received upon the outer surface area of a dental lamp head and interfacing formations 1110″, 1112″ that may be adapted to interface the light guide 1100″ with a lip retractor or other reference device. The light guide 1100″ may also include expansion section 1102″ and reference section 1104″ in its body. The reference section 1104″ may be substantially of a smaller span than the expansion section 1102″ such that it may fit within the expansion section 1102″. The expansion section 1102″ may be adapted to slide or otherwise move along the length of the reference section 1104″ such that the position of the expansion section 1102″ along the reference section 1104″ may substantially define the length of the light guide 1100″. The expansion section 1102″ and reference section 1104″ may include features that may provide for movement of the sections along each other. Such features may include, but are not limited to, corresponding tracks and rails, corresponding notches and bumps, corresponding threads, corresponding friction zones, and/or any other appropriate features. The features may also substantially lock the light guide 1100″ at a particular length during use and may be adjusted to different lengths by applied an appropriate force in the appropriate direction.

In alternative embodiments, the expansion section 1102″ may be of substantially the same span as the reference section 1104″. The expansion section 1102″ may include more than one section.

In other embodiments, the light guide 1100″ may be substantially similar to the light guide 1000 of FIG. 14 and may be extended with a snap-on extension section 1102″, as shown in FIG. 14b.

In one embodiment, an elastic protector 270 is mounted around the second opening 222′ of the light guide 106 to provide a soft interface between the light guide 106 and the patient. The elastic protector 270 may be made of any open-cell or closed-cell foam, rubber or elastomer, such as described above for the soft overlays, and is attached to the light guide 106 by means of heat sealing or an adhesive. In some embodiments, the elastic protector 270 may be present in pieces 272, 274, which may again be attached to the light guide 106 by means of heat sealing or an adhesive. Suitable adhesives may include, but are not limited to, structure adhesives, hot melt adhesives, pressure-sensitive adhesives, reactive adhesives or the like. Alternatively, suitable adhesives may be acrylic-based, polyurethane-based, epoxy-based, polyamide-based, styrene copolymer-based, polyolefin-based or similar. Further, the elastic protector pieces 272, 274 may also be integrally molded onto the light guide 106.

In the present embodiment, the elastic protector 270 is made in two pieces, an upper portion 272 and a lower portion 274, extending the slots 236′, 238′ of the light guide 106 so as to accommodate the wing-like members of an exemplary lip retracting device.

According to one embodiment of the invention, a light guide 106, such as that exemplified in FIG. 15a, is intended to be a single-use item, used for one patient, or one time dental whitening treatment, filling procedure, or imaging, and then discarded. With this in mind, in the illustrated embodiment of FIG. 15a, the light guide 106 further includes a memory integrated circuit 246′ disposed within a space 250′ molded into the underside of the light guide 106. The memory integrated circuit 246′ stores a record of a duration of use signal indicating how long the particular light guide has been in use. The light guide memory integrated circuit 246′ is part of a system for ensuring that the light guide 106 is not improperly reused.

The biocompostable or biodegradable polymers, including those mentioned above, are particularly suited for single use light guides.

In operation, the light guide 106 is attached to the lamp head housing 104. The light guide 106 has both a mechanical attachment mechanism (the slots 228′, 230′) as described above and an electrical contact 248 between the light guide memory integrated circuit 246′ and electronics in the lamp head housing 104. The electrical contact 248′ mates with a conductive projection in the lamp head forming an electromechanical connection that enables signaling between the light guide memory integrated circuit 246′ and electronics in the lamp head housing 104.

The light guide 106 is aligned with the patient's mouth using the positionability of the lamp system 100 and whitening treatment is administered. A signaling device within lamp head 102, or within the power pack, records duration of use of light guide usage onto the memory integrated circuit 246′. When a light guide usage limit is reached, the lamp system 100 precludes activation of the light source 300 in the lamp head housing 104 and the light guide 106 is replaced in order to operate the lamp system 100.

In an alternative embodiment of the light guide 106, no elastic protector 270 is used to interface between the light guide 106 and the patient. In further alternative embodiments of the light guide 106, the contact between the light guide memory integrated circuit 246′ and electronics in the lamp head 102 is a magnetic contact. Alternatively, the memory integrated circuit 246′ may communicate with the lamp head 102 through infrared radiation or through wireless radio signals or through light from the visible portion of the electromagnetic spectrum.

One of skill in the art will appreciate that when recording device 206 (as illustrated in FIG. 15) is disposed inwardly of aperture 202, surface 234 of integrated circuit memory device 212 is disposed adjacent to, and supported by bearing surface 3320. Furthermore, referring again to FIG. 18, one of skill in the art will appreciate that when recording device 206 is thus disposed, electromechanical contact 210 will be disposed in a region adjacent and rearwardly of bearing surface 3120 and will be exposed within axial cavity 1040 from above, below, and from a rearward direction.

The structure of a light guide may include a UV-inhibiting material in order to protect the patient's skin from ultra-violet light exposure. The light guide may be made of similar material as that of the lamp housing 104 and lamp head 102 as described above. Additionally, like the lamp housing 104 and the lamp head 102, a liquid crystal polymer, one that reflects rather than transmits light energy, may be used, either as a coating or as the main ingredient of the light guide to minimize escape of light energy.

For illustrative purposes, FIG. 16 shows a lamp head 400 which includes a housing 402 having an outer surface 404. A forward end of the lamp head housing 402 includes an aperture 406 defined by an edge 408. In operation, light is emitted from a light source within the lamp head housing 402 through the aperture 406.

The housing 402 includes an intermediate edge 410 disposed in a curve about aperture 406 in a forward region of the housing 402. Forwardly of the intermediate edge 410, a surface region 412 is recessed in relation to the balance of the housing surface 404.

According to one embodiment of the invention, the lamp head 400 is adapted to removably interface with a light guide such as that indicated, for example by reference 3000 in FIG. 18. Accordingly, surface region 412 is adapted to be disposed adjacent to and to be supported by, internal surface 1360 of light guide 3000. Likewise, rear edge 1300 of light guide 3000 is adapted to be disposed adjacent to and supported by edge 410.

In addition, according to one embodiment of the invention, the housing 402 includes a top recess 414, and a corresponding bottom recess (not shown). The top recess 414 is adapted to receive a first detent projection 420 (as shown in FIG. 18) disposed adjacent edge 1300 of light guide 3000. In like fashion, the bottom recess is adapted to receive a second detent projection 422 as shown in FIG. 18.

According to one embodiment of the invention, the material of the light guide is sufficiently elastic to urge detent projections 420 and 422 into their respective recesses, whereby the light guide is removably retained in position with axial cavity 104 disposed adjacent to aperture 406 out the lamp head.

According to one embodiment of the invention, when the light guide (e.g., 3000) is so disposed, the electromechanical contact 210 (as shown in FIG. 15) is disposed within an electrical plug on the lamp head. This is shown more clearly in FIG. 16a, which includes a further recessed region 421 in proximity to the front end 423 of the lamp head 400.

As shown in FIG. 16b, this further recessed region 421 is disposed adjacent to the electrical plug referred to immediately above, which is disposed behind an aperture 424 in the housing 402 of the lamp head 400. The aperture 424 is adapted in size and shape to receive the electromechanical connector 210, as shown in FIG. 15, therethrough.

As mentioned above, the interaction of detent projections 420, 422 and corresponding recesses, e.g., 414 of lamp housing 400 served to maintain the light guide in position on the lamp housing once it is installed there until it is actively removed.

A plurality of light guides having output ends of varying sizes corresponding to varying mouth sizes may be provided.

As also noted above, it is desirable to position and orient the lamp head in substantially fixed relation with respect to a target of the lamp's illumination, such as a tooth. For example, during a dental whitening process, it is desirable to maintain the distance and orientation between illumination source fixedly contained within the lamp head and a target tooth bearing a whitening compound, so as to maintain substantially uniform illumination intensity over the target tooth both spatially and during the duration of a whitening procedure.

One way of accomplishing this objective is through the use of a reference device, such as a lip retracting device 10, as shown in FIG. 17, which is adapted to also retract the upper and lower lips (herein “lips”) for facilitating examination and/or treatment of the mouth and/or teeth provided in accordance to one practice of the present invention. The lip retracting device 10, which may be also known as a tongur cup, includes four spaced apart channel retainers 12, 14, 16, 18, also known as flanges, for retaining four corresponding portions of the lips for examination and/or treatment of the mouth or teeth. When used, the lip retracting device 10 draws back the lips, which retracts the cheeks, to expose the mouth so that a health care professional can more easily see the teeth and work on the teeth and/or mouth.

The four channel retainers include two side channel retainers 12, 14 for retaining the ends of the lips, approximately where the upper and the lower lips intersect, and two lip channel retainers 16, 18 for retaining the mid-section of the upper and lower lips. More particularly, the four channel retainers or flanges 12, 14, 16, 18 are adapted to cup the lips and bias them open to expose the teeth for treatment and/or examination.

A plurality of resilient members 20 are incorporated in the lip retracting device 10 to interconnect the four channel retainers 12, 14, 16, 18 together and to function as biasing means. In the ready position (before insertion of the lip retracting device into the mouth), the resilient members 20 are arched outwardly with respect to the center portion of the lip retracting device 10. As further discussed below, when the lip retracting device 10 is inserted into the mouth and the four channel retainers 12, 14, 16, 18 cup respective portions of the lips, the resilient members 20 provide a retractive force to retract the lips radially outwardly for examination and/or treatment.

An optional tongue retainer 22 is shown approximately centrally positioned relative to the four channel retainers 12, 14, 16, 18. The tongue retainer may also be positioned asymmetrically about the two channel retainers 16 and 18. The tongue retainer 22 comprises a trough 23 and is attached to two channel retainers 12, 14 by a pair of secondary resilient members 24. When incorporated, the tongue retainer 22 and the secondary resilient members 24 cooperate to block the tongue and limit the tongue to the back vicinity of the mouth, thus enabling access to the lingual portion or back of the teeth for examination and/or treatment. In short, the tongue retainer is configured to minimize interference by the tongue during treatment and/or examination by a health care professional.

The side channel retainers 12, 14 resemble a curvilinear c-channel in that they include an arcuate race 26 and two channel side walls 28a, 28b. The channel side walls 28a, 28b resemble a bell shape and include a maximum wall dimension at approximately the mid-point 34 and two smaller tapered tips 36 at the ends thereof. In one embodiment, the inside side wall 28a, which is intraoral, as further discussed below, may be slightly larger relative to the outside side wall 28b. However, the relative dimensions may be reversed or may be the same without deviating from the functionality of the lip retracting device 10.

The side channel retainers 12, 14 further include an interior surface 30 and an exterior surface 32. The arcuate race 26 comprises a radius of curvature 31 adapted to mimic the curvature of the side of the lips when the lips are in the opened position. Because this curvature may vary depending on the size and age of the user or patient, the lip retracting device 10 may be implemented with varying radius of curvatures 31 to fit the varied shape of the particular user/patient. The arcuate race 26 may also include an irregular curvature or two or more different radii of curvatures. For example, the lower region 38 of the radius of curvature 31 may have a larger radius than the upper region 40 or vice versa. If implemented, the irregular curvature can vary the amount of retraction of the portion of the lip seated within the arcuate race to vary the amount of retraction between those portions of the lip. The two lip channel retainers 16, 18 may also have different radii of curvatures, similar to the side channel retainers 12, 14.

The lip channel retainers 16, 18, like the side channel retainers 12, 14, resemble a curvilinear c-channel in that they include an arcuate race 42 and two channel side walls 44a, 44b. In one embodiment, the radius of curvature 46 of the lip channel retainers is larger than the radius of curvature 31 of the side channel retainers 12, 14. The larger radius of curvature 46 enables the lip channel retainers 16, 18 to conform to the contour of the upper and lower lips near the frenum, which is more planar relative to the side of the lips. Depending on the size and age of the intended user/patient, the radius of curvature 46 of the lip channel retainer 16, 18 may also vary.

As shown, a frenum release 48 is incorporated in the inside side walls 44a of the lip channel retainers 16, 18 for providing relief to the frenum of the upper and lower lips. In one embodiment, the frenum release 48 includes a partial oval shaped cutout having a size sufficient to provide clearance for the frenum. In other words, the frenum release 48 should be such that the lowest most portion 50 of the frenum release only slightly touches the frenum when in use, and for example, does not touch the frenum. Although the oval shaped cutout is shown for the frenum release 48, a partial circle, a rectangular cutout, a square cutout, or other geometrical shaped cutout may also be incorporated without deviating from the function of the frenum release.

The lip retracting device 10 may be made by injection molding or casting a thermoplastic material such as polypropylene, polyethylene, polystyrene, polyester, polycarbonate or the like. The lip retracting device 10 may also be made out of biocompostable or biodegradable polymers mentioned above. More for example, the lip retracting device 10 may be made by injection molding polypropylene and may have a smooth and transparent finish.

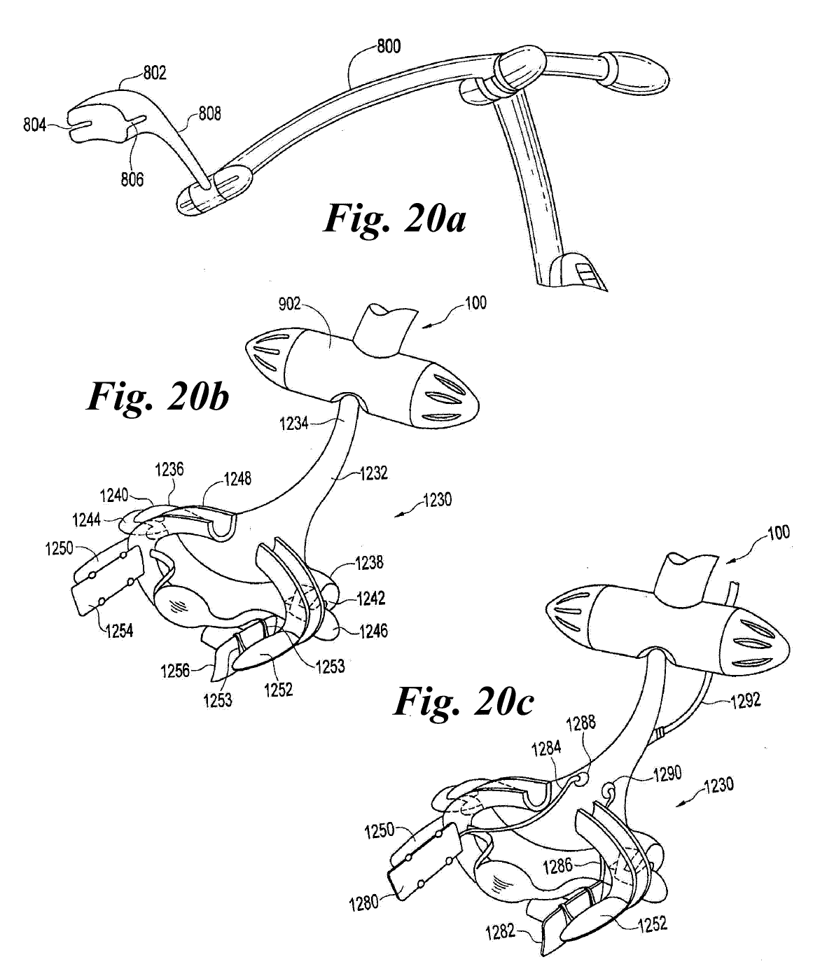

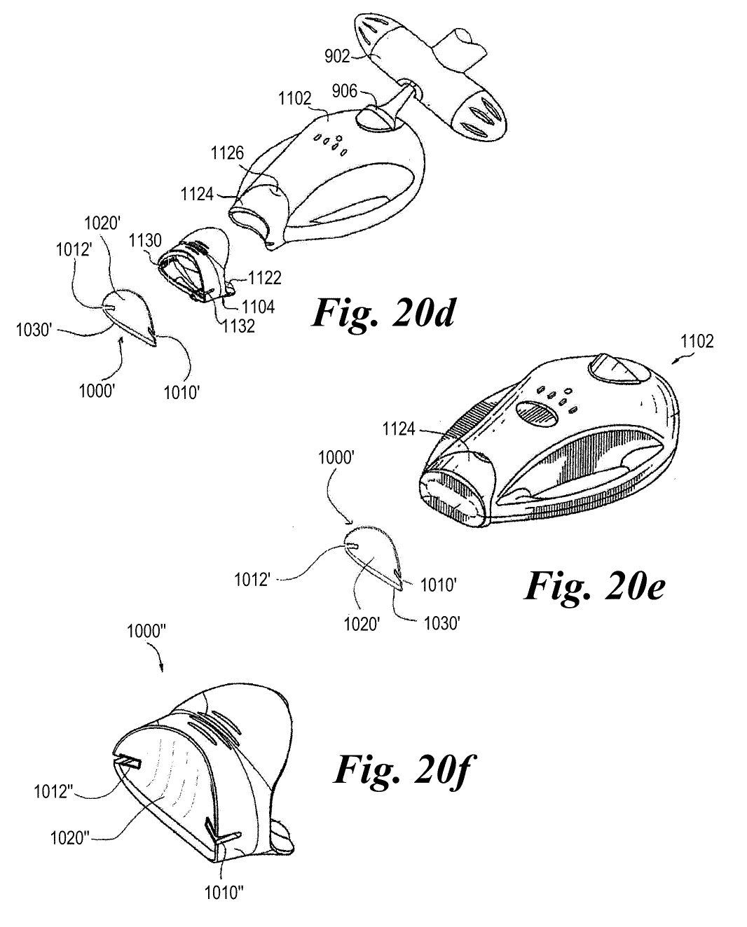

As shown in FIG. 17a, two wing-like flanges 111 may be incorporated in the lip retracting device of FIG. 17. These wing-like flanges 111 may be permanently attached by an adhesive or by heat sealing, or molded or cast integrally with the side channel flanges or retainers 12, 14, and may be constructed of the same or different material as the channel flanges or retainers, including the materials mentioned above. An exemplary illumination system is shown in FIG. 20, which is an exploded view of the combination of a lip retracting device 1138, a light guide 1104 and a lamp system 1102. The wing-like flanges 111 are designed for fitting into a pair of slots 1130, 1132 formed in the output port or light guide 1104 of a lamp system 1102 used in a whitening process or to the slots in any examination device. Another exemplary illumination system and the use of which is disclosed in Ser. No. 10/715,681, filed Nov. 17, 2003, which is expressly incorporated herein by reference as if set forth in full.

In another embodiment, instead of a light guide 1104, an examining device such as a cone-like structure, as mentioned above, may be configured to fit over the outlet of the lamp system 1102 and the wing-like flanges 111 on the lip retracting device 1138 may be configured to interact with the slots on the cone to thereby provide a consistent and controlled gap between the lamp system and the teeth of the patient to be treated or examined. The wing-like flanges 111 may be constructed in the manner shown and described above for the wing-like flanges with reference to FIGS. 17b and 18.

Referring now to FIG. 17b, there is shown another embodiment of a lip retracting device 10′ for retracting the lips for facilitating examination of the mouth and/or teeth, the whitening or curing process. The device includes two spaced apart channel retainers 12′, 14′, also known as flanges, for retaining two corresponding portions of the lips for examination and/or treatment of the mouth or teeth. When used, the lip retracting device 10′ draws back the lips, which retracts the cheeks, to expose the mouth so that a health care professional can more easily see the teeth and work on the teeth and/or mouth.

The two channel retainers 12′, 14′ are for retaining the ends of the lips, approximately where the upper and the lower lips intersect. More particularly, the two channel retainers or flanges 12′, 14′ are adapted to cup the lips and bias them in the open position to expose the teeth for treatment and/or examination.

A resilient member 20′ is incorporated in the lip retracting device 10′ to interconnect the two channel retainers 12′, 14′ together and to function as biasing means. The resilient member 20′ has two arches, one on either side of the center portion 22′. The resilient member 20′ may be formed as a single piece integrally molded or attached to the inside side walls 28a′ of the channel retainers 12′, 14′, or it may be formed in two halves separately connected to the mid-portion 22′, also integrally molded or attached to the inside side wall 28a′ of the channel retainers 12′, 14′. In the ready position (before insertion of the lip retracting device into the mouth), the resilient members 20′ are arched outwardly with respect to the center portion of the lip retracting device 10′. As further discussed below, when the lip retracting device 10′ is inserted into the mouth and the two channel retainers 12′, 14′ cup respective portions of the lips, the resilient members 20′ provide a retractive force to radially retract the lips outward for examination and/or treatment. This lip retracting device is especially useful for the whitening process.

An optional tongue retainer 22′ can also be approximately centrally positioned relative to the two channel retainers 12′, 14′. Like the tongue retainer 22 of FIG. 17, the tongue retainer 22′ of the present embodiment may also include a trough 23′. Further, it may be integrally formed on the mid-portion of the resilient member 20′ and thus be attached to the channel retainers 12′, 14′ via resilient member 20′. When incorporated, the tongue retainer blocks the tongue and limits the tongue to the back vicinity of the mouth, thus enabling access to the lingual portion or back of the teeth for examination and/or treatment. In short, the tongue retainer is configured to minimize interference by the tongue during treatment and/or examination by a health care professional. In this embodiment, the resilient member 20′ acts not only to connect the channel retainers and to bias them, but also to connect the tongue retainer to the channel retainers. If the tongue retainer 22′ is not incorporated, the resilient member 20′ would simply extend from one channel retainer 12′ to another channel retainer 14′ at a substantially uniform width.

The channel retainers 12′, 14′ resemble a curvilinear c-channel in that they include an arcuate race 26′ and two channel side walls 28a′, 28b′. The channel side walls 28a′, 28b′ resemble a bell shape and include a maximum wall dimension at approximately the mid-point 34′ and two smaller tapered tips 36′ at the ends thereof. In one embodiment, the inside side wall 28a′, which is intraoral, as further discussed below, is slightly larger relative to the outside side wall 28b′. However, the relative dimensions may be reversed or may be the same without deviating from the functionality of the lip retracting device 10′.

The side channel retainers 12′, 14′ further include an interior surface 30′ and an exterior surface 32′ and the description of FIG. 17 above also applies here. The arcuate race 26′ comprises a radius of curvature 31′ adapted to mimic the curvature of the side of the lips when the lips are in the opened position. Similarly, because this curvature may vary depending on the size and age of the user or patient, the lip retracting device 10′ may be implemented with varying radii of curvatures 31′ to fit the varied shape of the particular user/patient. The arcuate race 26′ may also include an irregular curvature or two or more different radii of curvatures. For example, the lower region 38′ of the radius of curvature 31′ may have a larger radius than the upper region 40′ or vice versa. If implemented, the irregular curvature may vary the amount of retraction of the portion of the lip that is seated within the arcuate race to vary the amount of retraction between those portions of the lip.

The lip retracting device 10′ may also be made by injection molding or casting a thermoplastic material such as those already mentioned. For example, the lip retracting device 10′ may be made by injection molding pigmented polypropylene and is opaque white or colored having a smooth finish.

Additionally, FIG. 17b also shows two formations in the shape of wing-like flanges 111 extending from the outside side wall 28b′ of the channel retainers 12′, 14′. The wing-like flanges 111 may be molded or cast integrally with the channel flanges or retainers 12′, 14′. As further discussed below, the wing-like flanges are designed for fitting the lip retracting device 10′ to the slots formed on a cone section of an output port or light guide of a lamp source used in a teeth whitening process, or to the slots in any examining device. As an example, FIG. 18 shows a bottom view of the lip retracting device 10′ with its wing-like flanges 111 engaging the slots on, for example, a light guide 106, which is attached to a lamp head 104 shown in dash-dot lines.

FIG. 19 shows a perspective view of an embodiment of a cheek retractor in accordance to one aspect of the invention. The cheek retractor 1400 may serve a purpose similar to that of the lip retracting device 10′ as discussed above. The cheek retractor 1400 may include two spaced apart channel retainers or flanges 1410 and 1420 for retaining corresponding portions of the upper and lower lips as well as at least a portion of the cheek on each side of the mouth where the upper and lower lips meet for examination and/or treatment of the mouth or teeth. When used, the cheek retractor 1400 draws back the lips, which retracts the cheeks, to expose the mouth so that a health care professional can more easily see the teeth and work on the teeth and/or mouth.

The two channel retainers 1410, 1420 are for retaining the ends of the lips, approximately where the upper and the lower lips intersect. More particularly, the two channel retainers or flanges 1410, 1420 are adapted to cup the lips and bias them in the open position to expose the teeth for treatment and/or examination.

The channel retainers 1410, 1420 resemble a curvilinear c-channel. The channel retainers 1410, 1420 may include interior surfaces 1411, 1421, respectively, that may directly contact the appropriate portions of the lips and cheeks of the patient.

The channel retainers 1410, 1420 may also include pads 1402 that may aid in cushioning the lips and increasing the comfort of the patient during use. The pads 1420 may occupy at least a portion of each end of the channel retainers 1410, 1420 and may substantially cover the underlying structure of the retainers. In this configuration, the pads 1402 may cushion the lips of the patient against the hard edges of the ends of the channel retainers 1410, 1420 and may aid in preventing painful contact between the hard material and the soft tissue and/or prevent minor injury to the soft tissue.

A resilient member 1430 is incorporated in the cheek retractor to interconnect the two channel retainers 1410, 1420 together and to function as biasing means. The resilient member 1430 may include a single main arch 1431 centered about the middle point of the resilient member 1430, as shown in FIG. 19b. The resilient member 1430 may further include two smaller arches 1432, 1433 on either end of the main arch 1431. The arches 1432, 1433 may have a curvature in the opposite orientation to the main arch 1431, but arches having similar or other orientations are also conceived. The resilient member 1430 may be formed as a single piece integrally molded or attached to the side walls of the channel retainers 1410, 1420, or it may be formed in two halves separately connected at the center of the main arch 1431, also integrally molded or attached to the side walls of the channel retainers 1410, 1420. In the ready position (before insertion of the lip retracting device into the mouth), the resilient member 1430 is arched outwardly with respect to the center portion of the cheek retractor 1400. When the cheek retractor 1400 is inserted into the mouth and the two channel retainers 1410, 1420 cup respective portions of the lips, the resilient member 1430 provides a retractive force to laterally retract the lips outward for examination and/or treatment. This cheek retractor is especially useful for the whitening process.

FIG. 19a shows another embodiment of a cheek retractor 1400′ in accordance with one aspect of the invention. The cheek retractor 1400′ is substantially identical to the cheek retractor 1400 of FIGS. 19, 19b with the exception of the wing-like flanges 1450, 1460 extending from the side walls of the channel retainers 1410, 1420, respectively. The wing-like flanges 1450, 1460 may be molded or cast integrally with the channel flanges or retainers 1410, 1420. As previously discussed above, the wing-like flanges are designed for fitting the cheek retractor 1400′ to the slots formed on a cone section of an output port or light guide of a lamp source used in a teeth whitening process, or to the slots in any examining device. The wing-like flanges 1450, 1460 may further include notches 1451, 1461, respectively, that may further aid in proper alignment of the cheek retractor 1400′ with the slots formed on a cone section of an output port or light guide of a lamp source used in a teeth whitening process, or to the slots in any examining device. The notches 1451, 1461 may be utilized to give a visual check of symmetrical alignment within the receiving slots.

The cheek retractors 1400, 1400′ may be made by injection molding or casting a thermoplastic material such as those already mentioned. For example, the cheek retractors 1400, 1400′ may be made by injection molding pigmented polypropylene and is opaque white or colored having a smooth finish.

FIG. 20 shows an assembly relationship between the ball joint 902 the lamp head 1102, a light guide 1104, and a lip retracting device 1138 according to one embodiment of the invention. A pivot mount 906 is coupled between the lamp head 1102 and the ball joint 902. The ball joint allows the lamp head to be swiveled in space such that an optical axis of the curing lamp is aligned with the target teeth of a dental whitening subject.

A light guide 1104 is adapted to be coupled to an anterior end of the lamp head 1102. In one embodiment, the light guide 1104 includes an inner surface region 1122 that is adapted to be held in proximity to an outer surface region 1124 of the lamp head 1102. According to one embodiment of the invention, a projecting member, or bump, on inner surface 1122 is adapted to be urged into a recessed region 1126 of outer surface region 1124.

In one embodiment of the invention, the light guide 1104 includes an elastically compressible cushion 1128 at an anterior edge thereof. The elastically compressible cushion 1128 serves to soften an interface between a dental whitening process subject (not shown) and the light guide.

In a further aspect of the invention, as shown in the illustrated embodiment, the light guide 1104 includes first and second slots 1130 and 1132. These slots are adapted to receive projecting wings 1134, 1136 of a lip retracting device 1138 so as to stabilize a relationship between the dental whitening subject and the lamp head 1102.

The lip retracting device 1138 includes channels 1140, 1142 adapted to support the lips of a dental whitening subject during the whitening process, and an elastic member 1144. The elastic or elastomeric member 1144 is coupled to the channels 1140, 1142 and adapted to urge the channels outwardly towards the lips, so as to couple the subject undergoing the dental process to the lip retracting device.

When the subject is coupled to the lip retracting device 1138, and the lip retracting device is coupled to the light guide 1104 by the insertion of wing-like members 1134, 1136 in the respective slots 1130, 1132 in the light guide 1104, the subject is spatially stabilized with respect to the lamp head 1102. In this way the support structure serves to support the lamp head in a substantially stable spatial relationship to the whitening subject.

As discussed above, this spatially stabilized relationship between a subject and the support structure of the invention is found in other embodiments of the invention and in relation to various apparatus and processes.

The use of light guides of the present invention may also promote less air circulation between the patient's mouth and the ambient surroundings. With less air circulation inside the mouth, there may be less evaporation of any treatment composition or whitening composition, which may lead to less dehydration of the mouth. Without wishing to be bound by a theory, it is surmised that since dehydration may lead to increased sensitivity, less dehydration of the mouth may lead to decreased dehydration of the teeth and thus decreased teeth sensitivity during and after treatment. Thus, the use of a light guide during bleaching process may potentially be advantageous.

In other embodiments, the lamp system 1102 assembly may include an optical filter 1000′, as shown in FIG. 20d. The optical filter 1000′ may include an optical window 1020′, which may be adapted to block certain wavelengths of electromagnetic radiation while allowing others to pass. In other embodiments, the optical window 1020′ may be adapted to block a certain percentage of particular wavelengths of electromagnetic radiation or of all wavelengths. The optical window 1020′, for example, a lens, may further be adapted to perform a variety of other functions, such as, but not limited to, diffusing exiting electromagnetic radiation, reducing emitted heat from the lamp system 1102, focusing exiting electromagnetic radiation, for example, performing the function of a lens, altering the wavelength of exiting electromagnetic radiation, converting electromagnetic radiation into electrical energy and/or spatially organizing emitted electromagnetic radiation.

The optical window 1020′ may be mounted in a frame 1030′, which may be adapted to allow the optical filter 1000′ to interface with a portion of the lamp system 1102. A mechanical interface may achieved by a variety of methods and may include, but are not limited to, magnetic attachment (which may include magnets in the frame 1030′ and the light guide 1104), adhesive attachment and/or mechanical attachment (such as clip-on, snap-on, etc. . . . ). The attachment may be substantially reversible or permanent, depending on the method(s) utilized. The optical filter 1000′ may be disposed substantially between the patient's mouth and the lamp system 1102. In some embodiments, the optical filter 1000′ may be disposed upon the light guide 1104 and may be utilized by attaching to the light guide 1104 prior to a whitening procedure. The optical filter 1000′ may include slits 1010′ and 1012′ that correspond to the slots 1132 and 1130 of the light guide 1104 and may be adapted to allow the wing-like formations 1136 and 1134 of a retractor 1138 (not shown) to properly interface with the light guide 1104 and the optical filter 1000′.

In other embodiments, the optical filter 1000′ may be disposed on the lamp system 1102, as shown in FIG. 20e. The lamp system 1102 may be mounted with an optical filter 1000′ by attaching proximal to the outer surface region 1124. The optical filter 1000′ may be adapted to achieve full coverage and/or physical contact with outer surface region 1124 so as to act upon all exiting electromagnetic radiation from the lamp system 1102. A light guide 1104 (not shown), may be disposed on the lamp system 1102, which may dispose the optical filter 1000′ substantially between the lamp system 1102 and the light guide 1104. This configuration may aid in reducing discomfort to the patient by, for example, increasing the distance between the optical filter 1000′ and the patient's mouth. As filters and other optically active elements are prone to heating by interaction with electromagnetic radiation, the position of the optical filter further from the patient may aide in reducing the effects of its heating on the patient's comfort.

In further embodiments, the light guide may include an integrated optical filter. FIG. 20f shows an embodiment of a light guide 1000″ that may include an integrated optical window 1020″ on the side proximal to the patient when mounted on a lamp system 1102 (not shown). In other embodiments, the optical window 1020″ may be disposed on the distal side (not shown). The optical window 1020″ may be adapted to achieve any combination of the functions of the optical filter 1000′ and light guide 1104 discussed above.

In embodiments designed to reduce the amount of electromagnetic radiation that exits from the dental whitening lamp, the optical filter window may be constructed from a variety of materials that may be suitable to block some or all of a specific range of frequencies of electromagnetic radiation. Suitable materials may include, for example, various plastics or polymers that are capable of blocking certain forms of electromagnetic radiation. Examples include, but are not limited to, polycarbonate, which may be utilized to partially block ultraviolet (UV) and pass visible light, CR-39 (allyl diglycol carbonate), which may be utilized to block UV and infrared while passing visible light, acrylic, which may partially block infrared above ˜2800 nm, or any other polymer with suitable optical properties. In addition, other materials such as sodium carbonate containing glass may be utilized to partially block UV while passing visible light.

In some embodiments, the optical filter window may be colored to substantially limit the frequencies of electromagnetic radiation passing through it.

In other embodiments, the optical filter window may be constructed with coatings, additives or doping to achieve the desired filtration characteristics. In some embodiments, opaque additives or thin layer coatings of opaque materials, such as aluminum and titanium oxides, may be utilized to partially block electromagnetic radiation passing through the optical window.

Surface coatings may be created by a variety of methods including, for example, plasma deposition, electroplating, precipitation, thin layer liquid coating, and/or any other suitable method that may produce a thin adherent layer on the desired substrate.

Additives may be incorporated into the optical window by a variety of methods including, for example, complexing within a polymer matrix, doping, chemically modifying the substrate, and/or other methods that may produce a desirable incorporation into the material of the optical window.

In some embodiments, the optical window may include coatings or additives that may allow the window to alter the spectrum of electromagnetic radiation passing through it. Wavelength altering materials or additives may be incorporated to, in general, lengthen the wavelength of specific ranges of electromagnetic radiation passing through the optical window. Wavelength altering materials or additives may include, but are not limited to, organic dyes or fluorophores, such as fluorescein, Texas Red (a sulfonyl chloride derivative of sulforhodamine 101), coumarin derivatives, ethidium bromide, SYBR Green, stilbenes, green fluorescent protein, anthracine derivatives and/or other suitable dyes/fluorophores that may produce desirable wavelength changes. In general, organic heterocyclic compounds may be incorporated to produce alterations in the electromagnetic spectrum of the radiation passing through the optical window.

In further embodiments, the optical window may include photochromic materials or compounds. Photochromics may be utilized to alter the optical properties of the optical window in response to exposure to given ranges of electromagnetic radiation. Photochromics may include, for example, organic photochromics such as triarylmethanes, stilbenes, azastilbenes, nitrones, fulgides, spiropyrans, naphthopyrans and spiro-oxazines when utilizing a polymer substrate for the optical window and inorganic photochromics such as microcrystalline silver halides when utilizing a glass substrate. The optical window may, in some aspects, be modified to darken when exposed to UV by absorbing the radiation and inducing changes in the electron bonding structure of the photochromic, usually causing the previously transparent compound to become opaque or colored, darkening the overall material. The darkened optical window may then at least partially block electromagnetic radiation passing through.

In yet further embodiments, the optical window may include irreversible photochromics that may be utilized to permanently darken the optical window after exposure to UV. Such embodiments may gradually darken during the course of use and may be discarded after reaching a certain level of opacity.

In still further embodiments, the optical window may be modified to reduce the heat effects associated with the dental whitening lamp. The optical window may, for example, include heat conductive materials in its construction and may be modified to direct heat away from the patient. In some aspects, the optical window may be thermally coupled to a heat sink or heat dissipater. Heat conductive materials may include, for example, thin layer metal depositions and/or conductive polymers such as polysulfone. In other aspects, the optical window may include additional insulating layers that may aid in preventing the transmission of heat from the dental whitening lamp to the patient. Insulating materials may include, for example, transparent alumina, polycarbonate, polystyrene and/or any other suitable material that may act as an effective insulator.

In yet still other embodiments, the filter system may be permanently positioned in the direct path of the light source and be electronically controlled to either change or not change the nature of the nature of the light coming from the light source. In one embodiment, for example, the filter system may be turned off so that it is transparent to the light coming from the light source so that it will transmit, for example, about 100% of the light of all wavelengths emitted by the light source. In another embodiment, the filter system may have varied effect on the light coming from the light source, for example, only transmitting a wavelength and blocking another wavelength. An electronic control may utilize a filter system that may include a liquid crystal, liquid crystal polymer and/or cholesteric liquid crystal polymer. In general, liquid crystals, liquid crystal polymers and/or cholesteric liquid crystal polymers may have a generally transparent state and a generally reflective or otherwise opaque state, which may be to all wavelengths of electromagnetic radiation or particular wavelength(s), and may be controlled by the application or removal of an external electric field. An electronically controlled filter system may utilize an applied electric field to control the transparent/opaque state of the optical filter that may include a liquid crystal, liquid crystal polymer and/or cholesteric liquid crystal polymer, which may be coated onto the filter, integrally incorporated and/or otherwise included in the construction of the filter. The extent of the electromagnetic blocking may be further be modulated by the amount of the material in the filter system, as in, for example, the thickness of a material layer. Such a filter system may also be utilized as a shutter that may substantially interrupt the emission of electromagnetic radiation. The shutter may be utilized in an on/off manner or, alternatively, it may be utilized with a continuously on light source to give the output electromagnetic radiation in bursts at a substantially continuous intensity, which may maximize the energy delivered to the target for a burst pattern, as it does not require the light source to power on and off, which may include the time necessary for the light source to reach its desired output power.

In one embodiment, the filter may also be part of the extension portion, of the light guide. In another embodiment, the filter may be attached to the extension portion of the light guide.

In some of the above embodiments, the various optical and/or physical properties of the optical window may be disposed on parts or the entirety of the optical window. The optical window may include multiple regions that may act with different optical and/or physical properties and may be adapted to fit in any desirable spatial arrangement.

In other embodiments, the optical filter may be used in conjunction with multiple light sources. Multiple light sources may be used to generate a desired frequency distribution of electromagnetic radiation. The optical filter may then be used to attenuate the less desired portions of the spectrum while allowing the passage at full or near full strength of the more desired wavelengths in the spectrum. This may be useful in increasing the useful effects of certain combined wavelengths while keeping the intensity of other frequencies low, which may prevent excess heat transmission and/or other deleterious effects to the patient.

In still other embodiments, a filter system may include multiple filters that may be changed based on the application. The filters may, for example, come in a set that may be manually placed, or, they may be mounted together in a switchable manner. A filter switching system may include, for example, a rotor that may house multiple filters which may be rotated to place a particular filter in the light path for an application.

FIG. 24 is a view of the power pack of the lamp of FIG. 1. The power pack 114 is mountable on the mast 110 as shown in FIG. 1. Various conventional mounting techniques (not shown) are applicable to mount the power pack 114 to the mast 110. The power pack 114 interfaces the power and I/O cables (not shown). The power pack 114 includes a control area 660. In this embodiment, the control area 660 includes a display window 662 and a plurality of control buttons 664-1, 664-2, 664-3, 664-4. The display window 662 displays, for example, elapsed treatment time or other treatment process information. The control buttons are, for example, “on”, “off”, “start”, and “pause.” The lamp operator operates the lamp system 100 using the controls and display on the control pack. Together with the indicators on the lamp head 102, the operator is able to monitor the lamp system 100 during treatment.

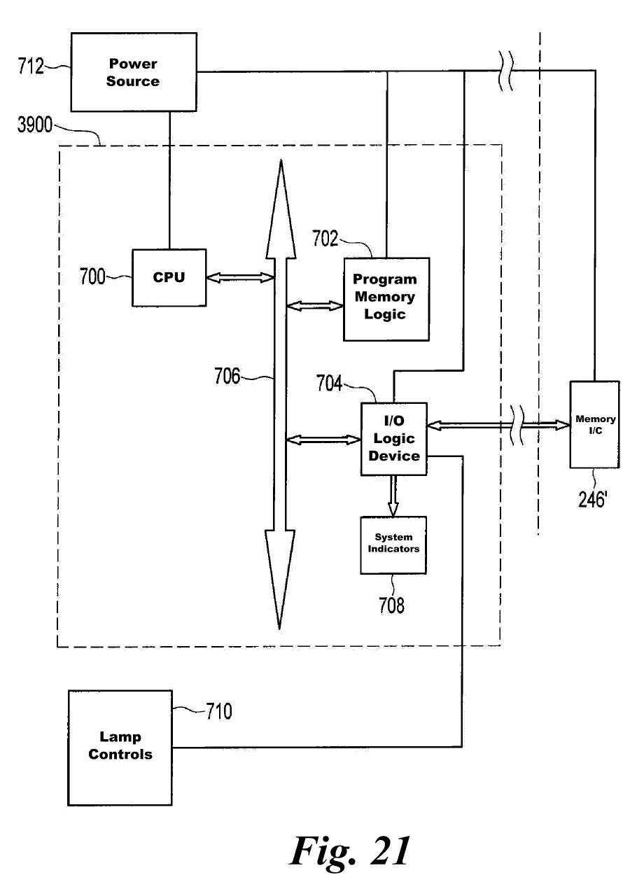

FIG. 21 is a block diagram of an embodiment of the control system 3900 of the lamp system 100 of the present invention. In one embodiment, the microelectronics of the control system 3900 are located in the lamp head 102. In another embodiment, the microelectronics of the control system 3900 are located in the power pack 114. Other locations for the control system electronics are possible within the scope of the invention.

The control system 3900 includes a CPU 700, program memory logic 702, an I/O logic device 704, a data bus 706 and system indicators 708. The CPU 700, program memory logic 702, and the I/O logic device 704 are connected to the data bus 706. The I/O logic device 704 is further connected to system indicators 708. In one embodiment of the invention, the I/O logic device 704 further includes device drivers. The I/O logic device 704 is further connected to the memory integrated circuit 246′ located on the light guide (shown in FIG. 15a). Lamp controls 710 are connected to the I/O device 704. A power source 712 provides power to the CPU 700, program memory logic 702, the I/O logic device 704 and the memory integrated circuit 246′.

The CPU 700, program memory logic 702 and the I/O logic device 704 are for example, microelectronic devices located in the lamp head 102. The program memory logic stores lamp usage limits, which includes a light source usage limit, a light guide usage limit, and a procedure time limit. In an alternative embodiment of the invention, the lamp controls 710 and power 712 are also located in the lamp head 102. In an alternative embodiment of the invention, the CPU 700, program memory logic 702, I/O logic device 704, lamp controls 710, and power 712 are, for example, located in the power pack 114. The lamp controls 710 are, for example, a transistor device or electronic or electromechanical relay device for controlling the on/off function of the lamp system 100. The system indicators 708 are, for example, the lighted indicators 150, 152 shown on the lamp head 102 in FIG. 6.

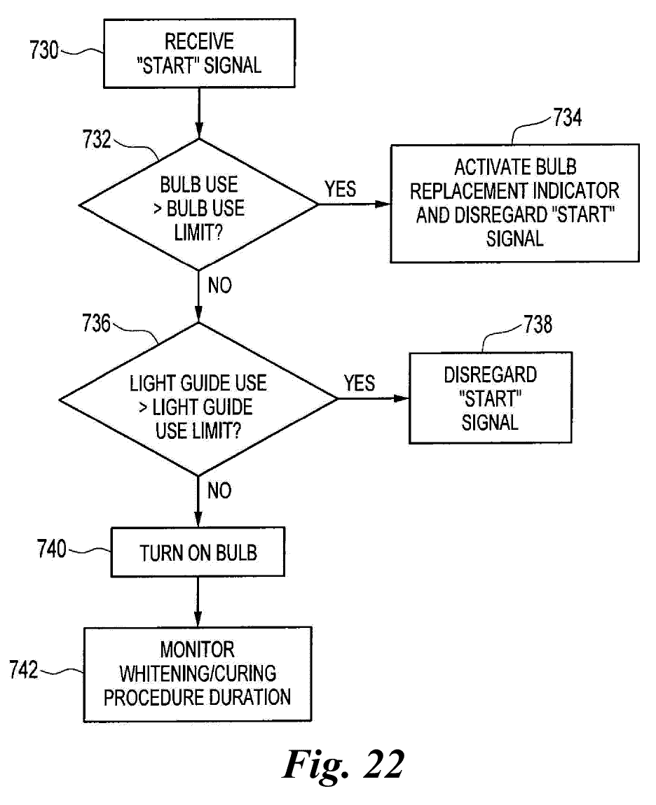

FIG. 22 is a flow chart showing one embodiment of the start process of the lamp system that is executed by the control system illustrated in FIG. 24.

At step 730, the control system 3900 receives a “start” signal from the lamp controls 710. The “start” signal activates an initializing process that includes determining whether the light source 300 and light guide have reached their usage limits. The control system 3900 stores a light source usage limit, a light guide usage limit, and a whitening/curing procedure time limit that is divided into preselected time periods.

At step 732, the control system 3900 checks whether the light source 300 has been used longer than the light source usage limit stored in the control system 3900. The light source usage limit is, for example, 100 hours. The control system 3900 monitors the time that the source 300 is on and adds this value to the amount of time accumulated from previous treatment procedures, if any. When the “start” signal is received from the lamp controls 710, the control system 3900 compares the accumulated light source on time with the light source usage limit. If the light source usage limit has been exceeded, the control system 3900 proceeds to step 734. If the light source usage limit has not been exceeded, the control system 3900 proceeds to step 736.

At step 734, the control system 3900 activates the light source replacement indicator 152 in the lamp head 102. In a first embodiment of the control system 3900, the control system continues with the process of starting the lamp system 100. In this embodiment, the control system 3900 proceeds to step 736. In a second embodiment of the control system 3900, the control system 3900 does not allow the lamp to be turned on. In this embodiment, the control system 3900 proceeds to step 738. In either embodiment, the control system 3900 is reset when the light source 300 is replaced.

At step 736, the control system 3900 determines whether the light guide usage has exceeded the light guide usage limit stored in the control system 3900. The light guide usage limit is typically the amount of time of a single whitening or curing treatment. The light guide usage limit is, for example, sixty minutes. The control system 3900, as mentioned above in step 732, monitors the time that the light source 300 is on. The control system 3900 writes the amount of time that the light source 300 has been on since the beginning of a treatment procedure to a recording device on the light guide 106. The recording device is, for example, a memory integrated circuit 246′. When the “start” signal is received from the lamp controls 710, the control system 3900 compares the light source “on” time stored on the recording device in the light guide 106 with the light guide use limit stored by the control system 3900. If the light guide use limit has been exceeded, the control system 3900 proceeds to step 738. If the light guide use limit has not been exceeded, the control system 3900 proceeds to step 740.

At step 738, the control system 3900 disregards the “start” signal with regard to turning the light source 300 on. That is, the control system 3900 does not allow the lamp system 100 to operate if the light guide lifetime has expired. This portion of the control system 3900 acts to prevent the light guide from being reused. The light guide 106 is intended to be a single-use device to be discarded after each whitening or curing treatment.

At step 740, the control system 3900 starts the lamp (i.e. turns on the light source 300).

At step 742, the control system 3900 monitors the whitening or curing treatment procedure time. In this step, the control system 3900 monitors the time that the light source 300 is on. The monitoring procedure of the control system 3900 is described below with regard to FIG. 14.

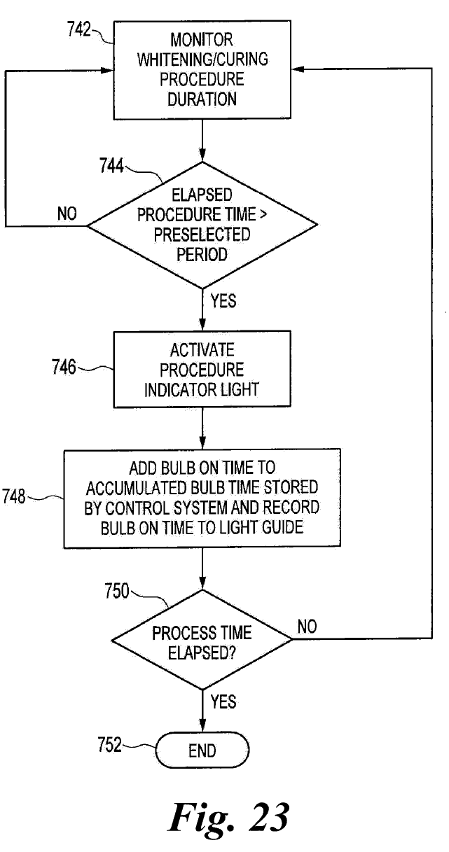

FIG. 23 is a flow chart showing one embodiment of the monitoring process of the lamp system that is executed by the control system illustrated in FIG. 14.

At step 742, the control system 3900 monitors the duration of the whitening or curing treatment, that is, the control system 3900 monitors the light source “on” time.

At step 744, the control system 3900 determines whether the elapsed procedure time has exceeded a preselected time period. Here, the preselected time period is some portion of the overall treatment time such as one quarter of the total treatment time. If the elapsed procedure time has not exceeded the preselected time period, the control system 3900 continues to monitor the treatment duration (step 742). If the elapsed procedure time does exceed the preselected time period, then the control system 3900 proceeds to step 746.

At step 746, the control system 3900 activates a procedure indicator light, for example one of the lighted indicators 150 described above with regard to FIG. 6. In one embodiment, the control system 3900 activates another lighted indicator 150 as each treatment portion time elapses so that if, for example, there are four lighted indicators, all four are lit at the end of the treatment procedure. In another embodiment, there is a single lighted indicator to indicate the time progression of the treatment. In this embodiment, the light indicator has varying flash rates to indicate the how much time has elapsed since the start of treatment. The control system 3900 then proceeds to step 748. In yet another embodiment, a voice alert system is used to alert the dental professional of the progress of the treatment, as described above.

At step 748, the control system 3900 adds the time that the light source has been on to the accumulated time that the control system 3900 has stored from previous treatment procedures, if any. The control system 3900 also writes the time that the light source has been on to the light guide recording device, such as the memory integrated circuit 246′. The control system 3900 then proceeds to step 750.

At step 750, the control system 3900 determines whether the overall process time has elapsed. The overall process time is the time duration of the whitening or curing treatment. If the overall process time has not elapsed, the control system 3900 returns to step 742, monitoring the whitening/curing duration. If the overall process time has elapsed, the control system 3900 proceeds to step 752.

At step 752, the duration of the whitening/curing treatment has elapsed and the control system 3900 turns off the light source 300.

In some exemplary embodiments, the dental illumination system may include means of shielding the electronics of the system from outside electromagnetic interference. With the prevalance of electronic devices and electromagnetic energy sources, it may be inevitable that a device may encounter stray electromagnetic energy that may interfere with its function and/or operation. Examples of sources of electromagnetic interference include, but are not limited to, telephones, radio transmissions, microwave emissions, X-ray equipment, televisions, power lines, computers, automobiles, other dental equipment and/or any other device that utilizes, generates and/or stores electromagnetic energy. Outside electromagnetic energy may interact with circuitry and electrical systems, which may lead to disruption and/or damage of an electrical and/or electronic system.

A means of shielding against electromagnetic interference may include, for example, an electromagnetic barrier that may substantially surround or encompass the electrical and electronic components of a dental illumination system. Such a barrier may include a variety of means that may allow it to shield its contents from outside electromagnetic energy and may include, but are not limited to, conductive shielding, absorptive shielding, diffusing shielding and/or any other means that may allow the barrier to substantially shield its contents from electromagnetic energy.

In an exemplary embodiment, a dental illumination system may utilize a conductive barrier. Conductive barriers may operate in a manner described as a Faraday Cage, wherein an outside electric field may be shielded by substantially surrounding an area or space with a conductive shell of material. FIG. 25 illustrates the concept of a Faraday Cage where a conductive shell 880 may substantially surround and/or encompass an area or space 882 that may contain electric and/or electronic equipment. An external electric field EF may be substantially excluded from the interior space 882 due to the conductive nature of the shell 880. The shell 880 may form a current IC that may carry the energy of the electric field EF through the shell 880, which may substantially remove the presence of an internal electric field within the space 882 due to the removal of an electric potential across the interior of the shell 880.

A conductive shell may be constructed with any suitable conductive material or materials, which may include, but are not limited to, metals and metal alloys, such as copper, silver, gold, iron, steel, lead, and aluminum, conductive polymers such as poly(acetylene)s, poly(pyrrole)s, poly(thiophene)s, poly(aniline)s, poly(fluorene)s, Poly(3-hexylthiophene), polynaphthalenes, poly(p-phenylene sulfide), and poly(para-phenylene vinylene)s, and/or any other suitable conductive material.

In an exemplary embodiment, a conductive shell may be formed by painting or otherwise coating the housing of an electrical system, such as a dental lamp head, for example, when the lamphead is made of a non-conductive material, with a conductive paint, such as, for example, copper based paint. In other embodiments, a metallic or other conductive housing structure may be utilized.

In other aspects, an electromagnetic barrier may also provide for containing electromagnetic energy. In many countries, the emission of electromagnetic radiation is regulated for various health and/or safety reasons. The emission of electromagnetic radiation from a device may cause interference with other equipment, as in the cases discussed above.

An electromagnetic barrier may serve to contain electromagnetic radiation generated by the electrical and electronic components of a dental illumination system. For example, conductive materials, such as metals, may be capable of substantially reflecting electromagnetic radiation. One physical response of conductive materials, referred to as plasmon resonance, defines a threshold of electromagnetic radiation that may be reflected by a metal based on its electron response to incoming radiation. In general, the plasmon frequency of a material defines the point that electromagnetic radiation of a higher frequency is transmitted while frequencies below are reflected. In many metals, this frequency is in the ultraviolet range of the electromagnetic spectrum, making metals effective reflectors at lower frequencies such as the visible, infrared, microwave and radio ranges of the spectrum.

In other embodiments, an electromagnetic barrier may be constructed such that it may substantially shield and/or contain electromagnetic energy by virtue of its material density.

In still other embodiments, an electromagnetic barrier may be constructed with energy absorbing materials.

In yet still other embodiments, an electromagnetic barrier may include materials that may substantially diffuse and/or redirect electromagnetic energy.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. An apparatus for positioning a dental illumination system comprising:
a retracting device adapted for retracting at least one portion of a subject's lips;
a lamp head comprising at least one formation adapted for engaging the retracting device;
at least one light source inside said lamp head; and
at least one filter system positioned in front of the lamp head adapted for altering the nature of light coming from the light source.

2. The apparatus of claim 1 wherein said filter system comprises an optically active element.

3. The apparatus of claim 1 wherein said filter system is permanently positioned in front of the lamp head for electronically controlling the light coming from the light source.

4. The apparatus of claim 1 wherein said filter system is attached to the at least one formation of the lamp head.

5. The apparatus of claim 1 wherein said filter system is attached directly to the lamp head.

6. The apparatus of claim 1, wherein the formation of the lamp system comprises a spacer.

7. The apparatus of claim 6 wherein said retracting device comprises at least one formation that inter-engages the spacer as the retracting device and spacer become apposed.

8. The apparatus of any of claim 6 wherein said spacer comprises a light guide.

9. The apparatus of claim 1 wherein said lamp head comprises an illumination frame having at least one light source in a geometric arrangement.

10. The apparatus of claim 9 wherein said illumination frame comprises of an arcuate form.

11. The apparatus of claim 8 wherein said light guide is removably attached to said housing.

12. The apparatus of claim 1 wherein said at least one formation has a length adapted for fixing the distance between the lamphead and a target.

13. The apparatus of claim 12 wherein said length of at least said formation is variable.

14. The apparatus of claim 13 wherein said at least one formation comprises features for fixing the length of said formation.

15. A dental illumination system comprising:
a lamp head comprising a housing;
an adjustable self-supporting frame comprising at least one reference device adapted to removably mechanically couple to said lamp head;
wherein said frame comprises a portion of a dental chair, a portion of a wall, floor or ceiling of a dental office or a mobile base.

16. The dental illumination system of claim 15 wherein said portion of the dental chair comprise a chair back, an arm of the chair or an armrest of the chair.

17. The dental illumination system of claim 15 wherein said self-supporting frame comprises:
a mast removably attached to the portion of the dental chair in a substantially perpendicular direction to the portion; and
a boom having two ends, one end of which is removably attached to the mast in a substantially perpendicular direction to the mast.

18. The dental illumination system of claim 17 wherein said boom comprises at least one formation coupled to one end of said boom, said formation comprises a ball cavity, wherein said cavity having a corresponding concave spheroid surface adapted to receive the ball member to form a ball joint.

19. The dental illumination system of claim 15 wherein said boom comprises at least one formation spaced away from one end of said boom, wherein said at least one formation comprises a boom joint adapted for coupling the mast to the boom to form an articulated support system.

20. The dental illumination system of claim 15 wherein said lamphead comprises a light guide comprising a coupling feature adapted to removably couple the light guide to a reference device for positioning the light guide, the lamp head and the light source in a substantially constant position and orientation with respect to a target.

21. The dental illumination system of claim 20 wherein said lightguide has a length adapted for fixing the distance between the lamphead and a target.

22. The dental illumination system of claim 15 wherein said lamphead comprises an electromagnetic shielding.

23. A dental illumination system comprising:
a lamp head housing having an internal surface and a cavity within said housing, said in internal surface including a first edge, said first edge defining a first aperture;
a light module being disposed within said cavity, said light module comprising a first reflector having an axis of illumination passing through said first aperture; and
a mechanical coupling device, said mechanical coupling device having a length, adapted to couple said housing to a lip retracting device for facilitating the illumination of a target along said axis of illumination.

24. The illumination system of claim 23 further comprising a filter system attached to said housing in front of said aperture.

25. The illumination system of claim 24 wherein said filter system is permanently positioned in front of the lamp head for electronically controlling the light coming from the light source.

25. The illumination system of claim 24 wherein said filter system is attached to the coupling device or is attached directly to the lamp head housing.

26. The illumination system of claim 23 wherein said length of said coupling device is variable.
